(19) United States
(12) Patent Application Publication
(10) Pub. No.: US 2018/0338212 A1
(43) Pub. Date: Nov. 22, 2018

(54) LAYERED INTERMEDIATE COMPRESSION FOR HIGHER ORDER AMBISONIC AUDIO DATA

(71) Applicant: QUALCOMM Incorporated, San Diego, CA (US)

(72) Inventors: Moo Young Kim, San Diego, CA (US); Nils Günther Peters, San Diego, CA (US); Dipanjan Sen, San Diego, CA (US)

(21) Appl. No.: 15/804,718

(22) Filed: Nov. 6, 2017

Related U.S. Application Data
(60) Provisional application No. 62/508,097, filed on May 18, 2017.

(51) Int. Cl. H04S 7/00; G10L 19/008; H04R 1/40; H04R 3/00; H04S 3/00

(52) U.S. Cl. CPC H04S 7/30; G10L 19/008; H04R 1/406; H04S 2420/11; H04S 3/008; H04S 2400/01; H04S 2400/15; H04R 3/005

(57) ABSTRACT

In general, techniques are described for performing layered intermediate compression for higher order ambisonic (HOA) audio data. A device comprising a memory and a processor may be configured to perform the techniques. The memory may store HOA coefficients of the HOA audio data. The processors may decompose the HOA coefficients into a predominant sound component and a corresponding spatial component. The spatial component may be representative of the directions, shape, and width of the predominant sound component, and defined in the spherical harmonic domain. The processor may specify, in a bitstream conforming to an intermediate compression format, a subset of the HOA coefficients that represent an ambient component. The processor may also specify, in the bitstream and irrespective of a determination of a minimum number of ambient channels and a number of elements to specify in the bitstream for the spatial component, all elements of the spatial component.

This application claims the benefit of the U.S. Provisional Application No. 62/508,097, entitled “LAYERED INTERMEDIATE COMPRESSION FOR HIGHER ORDER AMBISONIC AUDIO DATA,” filed May 18, 2017, the entire contents of which are incorporated by reference as if set forth in their entirety herein.

### TECHNICAL FIELD

This disclosure relates to audio data and, more specifically, compression of audio data.

### BACKGROUND

A higher order ambisonic (HOA) signal (often represented by a plurality of spherical harmonic coefficients (SHC) or other hierarchical elements) is a three-dimensional (3D) representation of a soundfield. The HOA or SHC representation may represent this soundfield in a manner that is independent of the local speaker geometry used to playback a multi-channel audio signal rendered from this SHC signal. The SHC signal may also facilitate backwards compatibility as the SHC signal may be rendered to well-known and highly adopted multi-channel formats, such as a 5.1 audio channel format or a 7.1 audio channel format. The SHC representation may therefore enable a better representation of a soundfield that also accommodates backward compatibility.

### SUMMARY

In general, techniques are described for mezzanine compression of higher order ambisonics audio data. Higher order ambisonics audio data may comprise at least one spherical harmonic coefficient corresponding to a spherical harmonic basis function having an order greater than one and, in some examples, a plurality of spherical harmonic coefficients corresponding multiple spherical harmonic basis functions having an order greater than one.

In one example, a device configured to compress higher order ambisonic audio data representative of a soundfield comprises a memory configured to store higher order ambisonic coefficients of the higher order ambisonic audio data; and one or more processors configured to decompose the higher order ambisonic coefficients into a predominant sound component and a corresponding spatial component, the corresponding spatial component representative of the directions, shape, and width of the predominant sound component, and defined in the spherical harmonic domain, disable, prior to being specified in a bitstream conforming to an intermediate compression format, application of decorrelation to a subset of the higher order ambisonic coefficients that represent an ambient component of the soundfield, specify, in the bitstream, the subset of the higher order ambisonic coefficients, and specify, in the bitstream, all elements of the spatial component, wherein at least one of the elements of the spatial component includes information that is redundant with respect to information provided by the subset of the higher order ambisonic coefficients.

In another example, a method to compress higher order ambisonic audio data representative of a soundfield comprises decomposing higher order ambisonic coefficients representative of a soundfield into a predominant sound component and a corresponding spatial component, the corresponding spatial component representative of the directions, shape, and width of the predominant sound component, and defined in the spherical harmonic domain, disabling, prior to being specified in a bitstream conforming to an intermediate compression format, application of decorrelation to a subset of the higher order ambisonic coefficients that represent an ambient component of the soundfield, specifying, in the bitstream, the subset of the higher order ambisonic coefficients, and specifying, in the bitstream, all elements of the spatial component, wherein at least one of the elements of the spatial component includes information that is redundant with respect to information provided by the subset of the higher order ambisonic coefficients.

In another example, a non-transitory computer-readable storage medium has stored thereon instructions that, when executed, cause one or more processors to decompose higher order ambisonic coefficients representative of a soundfield into a predominant sound component and a corresponding spatial component, the corresponding spatial component representative of the directions, shape, and width of the predominant sound component, and defined in the spherical harmonic domain, disable, prior to being specified in a bitstream conforming to an intermediate compression format, application of decorrelation to a subset of the higher order ambisonic coefficients that represent an ambient component of the soundfield, specify, in the bitstream, the subset of the higher order ambisonic coefficients, and specify, in the bitstream, all elements of the spatial component, wherein at least one of the elements of the spatial component includes information that is redundant with respect to information provided by the subset of the higher order ambisonic coefficients.

In another example, a device configured to compress higher order ambisonic audio data representative of a soundfield comprises means for decomposing higher order ambisonic coefficients representative of a soundfield into a predominant sound component and a corresponding spatial component, the corresponding spatial component representative of the directions, shape, and width of the predominant sound component, and defined in the spherical harmonic domain, means for disabling, prior to being specified in a bitstream conforming to an intermediate compression format, application of decorrelation to a subset of the higher order ambisonic coefficients that represent an ambient component of the soundfield, means for specifying, in the bitstream, the subset of the higher order ambisonic coefficients, and means for specifying, in the bitstream, all elements of the spatial component, wherein at least one of the elements of the spatial component includes information that is redundant with respect to information provided by the subset of the higher order ambisonic coefficients.

In another example, a device configured to compress higher order ambisonic audio data representative of a soundfield comprises a memory configured to store higher order ambisonic coefficients of the higher order ambisonic audio data; and one or more processors configured to decompose the higher order ambisonic coefficients into a predominant sound component and a corresponding spatial component, the corresponding spatial component representative of the directions, shape, and width of the predominant sound component, and defined in the spherical harmonic domain, specify, in a bitstream conforming to an intermediate compression format, the predominant audio signal, disable, prior to being specified in the bitstream, application of decorrelation to a subset of the higher order ambisonic coefficients that represent an ambient component of the soundfield, and specify, in the bitstream, the subset of the higher order ambisonic coefficients, wherein at least one of the subset of the higher order ambisonic coefficients includes information that is redundant with respect to information provided by the predominant audio signal and the corresponding spatial component.

In another example, a method to compress higher order ambisonic audio data representative of a soundfield comprises decomposing higher order ambisonic coefficients representative of a soundfield into a predominant sound component and a corresponding spatial component, the corresponding spatial component representative of the directions, shape, and width of the predominant sound component, and defined in the spherical harmonic domain, specifying, in a bitstream conforming to an intermediate compression format, the predominant audio signal, disabling, prior to being specified in the bitstream, application of decorrelation to a subset of the higher order ambisonic coefficients that represent an ambient component of the soundfield, and specifying, in the bitstream, the subset of the higher order ambisonic coefficients, wherein at least one of the subset of the higher order ambisonic coefficients includes information that is redundant with respect to information provided by the predominant audio signal and the corresponding spatial component.

In another example, a non-transitory computer-readable storage medium has stored thereon instructions that, when executed, cause one or more processors to decompose higher order ambisonic coefficients representative of a soundfield into a predominant sound component and a corresponding spatial component, the corresponding spatial component representative of the directions, shape, and width of the predominant sound component, and defined in the spherical harmonic domain, specify, in a bitstream conforming to an intermediate compression format, the predominant audio signal, disable, prior to being specified in the bitstream, application of decorrelation to a subset of the higher order ambisonic coefficients that represent an ambient component of the soundfield, and specify, in the bitstream, the subset of the higher order ambisonic coefficients, wherein at least one of the subset of the higher order ambisonic coefficients includes information that is redundant with respect to information provided by the predominant audio signal and the corresponding spatial component.

In another example, a device configured to compress higher order ambisonic audio data representative of a soundfield comprises means for decomposing higher order ambisonic coefficients representative of a soundfield into a predominant sound component and a corresponding spatial component, the corresponding spatial component representative of the directions, shape, and width of the predominant sound component, and defined in the spherical harmonic domain, means for specifying, in a bitstream conforming to an intermediate compression format, the predominant audio signal, means for disabling, prior to being specified in the bitstream, application of decorrelation to a subset of the higher order ambisonic coefficients that represent an ambient component of the soundfield, and means for specifying, in the bitstream, the subset of the higher order ambisonic coefficients, wherein at least one of the subset of the higher order ambisonic coefficients includes information that is redundant with respect to information provided by the predominant audio signal and the corresponding spatial component.

In another example, a device configured to compress higher order ambisonic audio data representative of a soundfield comprises a memory configured to store higher order ambisonic coefficients of the higher order ambisonic audio data, and one or more processors configured to decompose the higher order ambisonic coefficients into a predominant sound component and a corresponding spatial component, the corresponding spatial component representative of the directions, shape, and width of the predominant sound component, and defined in the spherical harmonic domain, specify, in a bitstream conforming to an intermediate compression format, a subset of the higher order ambisonic coefficients that represent an ambient component of the soundfield, and specify, in the bitstream and irrespective of a determination of a minimum number of ambient channels and a number of elements to specify in the bitstream for the spatial component, all elements of the spatial component.

In another example, a method to compress higher order ambisonic audio data representative of a soundfield comprises decomposing higher order ambisonic coefficients representative of a soundfield into a predominant sound component and a corresponding spatial component, the corresponding spatial component representative of the directions, shape, and width of the predominant sound component, and defined in the spherical harmonic domain, specifying, in a bitstream conforming to an intermediate compression format, a subset of the higher order ambisonic coefficients that represent an ambient component of the soundfield, and specifying, in the bitstream and irrespective of a determination of a minimum number of ambient channels and a number of elements to specify in the bitstream for the spatial component, all elements of the spatial component.

In another example, a non-transitory computer-readable storage medium has stored thereon instructions that, when executed, cause one or more processors to decompose higher order ambisonic coefficients representative of a soundfield into a predominant sound component and a corresponding spatial component, the corresponding spatial component representative of the directions, shape, and width of the predominant sound component, and defined in the spherical harmonic domain, specify, in a bitstream conforming to an intermediate compression format, a subset of the higher order ambisonic coefficients that represent an ambient component of the soundfield, and specify, in the bitstream and irrespective of a determination of a minimum number of ambient channels and a number of elements to specify in the bitstream for the spatial component, all elements of the spatial component.

In another example, a device configured to compress higher order ambisonic audio data representative of a soundfield comprises means for decomposing higher order ambisonic coefficients representative of a soundfield into a predominant sound component and a corresponding spatial component, the corresponding spatial component representative of the directions, shape, and width of the predominant sound component, and defined in the spherical harmonic domain, means for specifying, in a bitstream conforming to an intermediate compression format, a subset of the higher order ambisonic coefficients that represent an ambient component of the soundfield, and means for specifying, in the bitstream and irrespective of a determination of a minimum number of ambient channels and a number of elements to specify in the bitstream for the spatial component, all elements of the spatial component.

In another example, a device configured to compress higher order ambisonic audio data representative of a soundfield comprises a memory configured to store higher order ambisonic coefficients of the higher order ambisonic audio data, and one or more processors configured to decompose the higher order ambisonic coefficients into a predominant sound component and a corresponding spatial component, the corresponding spatial component representative of the directions, shape, and width of the predominant sound component, and defined in the spherical harmonic domain, specify, in a bitstream conforming to an intermediate compression format, the predominant audio signal and the spatial component, and specify, in the bitstream and irrespective of a determination of a minimum number of ambient channels and a number of elements to specify in the bitstream for the spatial component, a fixed subset of the higher order ambisonic coefficients that represent an ambient component of the soundfield.

In another example, a method to compress higher order ambisonic audio data representative of a soundfield comprises decomposing higher order ambisonic coefficients representative of a soundfield into a predominant sound component and a corresponding spatial component, the corresponding spatial component representative of the directions, shape, and width of the predominant sound component, and defined in the spherical harmonic domain, specifying, in a bitstream conforming to an intermediate compression format, the predominant audio signal, and specifying, in the bitstream and irrespective of a determination of a minimum number of ambient channels and a number of elements to specify in the bitstream for the spatial component, a fixed subset of the higher order ambisonic coefficients that represent an ambient component of the soundfield.

In another example, a non-transitory computer-readable storage medium has stored thereon instructions that, when executed, cause one or more processors to decompose higher order ambisonic coefficients representative of a soundfield into a predominant sound component and a corresponding spatial component, the corresponding spatial component representative of the directions, shape, and width of the predominant sound component, and defined in the spherical harmonic domain, specify, in a bitstream conforming to an intermediate compression format, the predominant audio signal, and specify, in the bitstream and irrespective of a determination of a minimum number of ambient channels and a number of elements to specify in the bitstream for the spatial component, a fixed subset of the higher order ambisonic coefficients that represent an ambient component of the soundfield.

In another example, a device configured to compress higher order ambisonic audio data representative of a soundfield comprises means for decomposing higher order ambisonic coefficients representative of a soundfield into a predominant sound component and a corresponding spatial component, the corresponding spatial component representative of the directions, shape, and width of the predominant sound component, and defined in the spherical harmonic domain, means for specifying, in a bitstream conforming to an intermediate compression format, the predominant audio signal, and means for specifying, in the bitstream and irrespective of a determination of a minimum number of ambient channels and a number of elements to specify in the bitstream for the spatial component, a fixed subset of the higher order ambisonic coefficients that represent an ambient component of the soundfield.

The details of one or more aspects of the techniques are set forth in the accompanying drawings and the description below. Other features, objects, and advantages of these techniques will be apparent from the description and drawings, and from the claims.

### BRIEF DESCRIPTION OF DRAWINGS

FIG. 1 is a diagram illustrating spherical harmonic basis functions of various orders and sub-orders.

FIG. 2 is a diagram illustrating a system that may perform various aspects of the techniques described in this disclosure.

FIGS. 3A-3D are diagrams illustrating different examples of the system shown in the example of FIG. 2.

FIG. 4 is a block diagram illustrating another example of the system shown in the example of FIG. 2.

FIGS. 5A and 5B are block diagrams illustrating examples of the system of FIG. 2 in more detail.

FIG. 6 is a block diagram illustrating an example of the psychoacoustic audio encoding device shown in the examples of FIGS. 2-5B.

FIGS. 7A-7C are diagrams illustrating example operation for the mezzanine encoder and emission encoders shown in FIG. 2.

FIG. 8 is a diagram illustrating the emission encoder of FIG. 2 in formulating a bitstream 21 from the bitstream 15 constructed in accordance with various aspects of the techniques described in this disclosure.

FIG. 9 is a block diagram illustrating a different system configured to perform various aspects of the techniques described in this disclosure.

FIG. 10-12 are flowcharts illustrating example operation of the mezzanine encoder shown in the examples of FIGS. 2-5B.

FIG. 13 is a diagram illustrating results from different coding systems, including one performing various aspects of the techniques set forth in this disclosure, relative to one another.

### DETAILED DESCRIPTION

There are various ‘surround-sound’ channel-based formats in the market. They range, for example, from the 5.1 home theatre system (which has been the most successful in terms of making inroads into living rooms beyond stereo) to the 22.2 system developed by NHK (Nippon Hoso Kyokai or Japan Broadcasting Corporation). Content creators (e.g., Hollywood studios) would like to produce the soundtrack for a movie once, and not spend effort to remix it for each speaker configuration. A Moving Pictures Expert Group (MPEG) has released a standard allowing for soundfields to be represented using a hierarchical set of elements (e.g., Higher-Order Ambisonic—HOA—coefficients) that can be rendered to speaker feeds for most speaker configurations, including 5.1 and 22.2 configuration whether in location defined by various standards or in non-uniform locations.

MPEG released the standard as MPEG-H 3D Audio standard, formally entitled “Information technology—High efficiency coding and media delivery in heterogeneous environments—Part 3: 3D audio,” set forth by ISO/IEC JTC 1/SC 29, with document identifier ISO/IEC DIS 23008-3, and dated Jul. 25, 2014. MPEG also released a second edition of the 3D Audio standard, entitled “Information technology—High efficiency coding and media delivery in heterogeneous environments—Part 3: 3D audio, set forth by ISO/IEC JTC 1/SC 29, with document identifier ISO/IEC 23008-3:201x(E), and dated Oct. 12, 2016. Reference to the “3D Audio standard” in this disclosure may refer to one or both of the above standards.

As noted above, one example of a hierarchical set of elements is a set of spherical harmonic coefficients (SHC). The following expression demonstrates a description or representation of a soundfield using SHC:

$${p}_{i} ( t , {r}_{r} , {θ}_{r} , {ϕ}_{r} ) = {\sum }_{ω = 0}^{∞} [ 4 π {\sum }_{n = 0}^{∞} {j}_{n} ( {kr}_{r} ) {\sum }_{m = - n}^{n} {A}_{n}^{m} ( k ) {Y}_{n}^{m} ( {θ}_{r} , {ϕ}_{r} ) ] {e}^{j ω t} ,$$

The expression shows that the pressure pᵢ at any point {rᵣ,θᵣ,φᵣ} of the soundfield, at time t, can be represented uniquely by the SHC, Aₙ^{m}(k). Here,

$$k = \frac{ω}{c} ,$$

c is the speed of sound (˜343 m/s), {rᵣ,θᵣ,φᵣ} is a point of reference (or observation point), jₙ(⋅) is the spherical Bessel function of order n, and Yₙ^{m}(θᵣ,φᵣ) are the spherical harmonic basis functions (which may also be referred to as a spherical basis function) of order n and suborder m. It can be recognized that the term in square brackets is a frequency-domain representation of the signal (i.e., S(ω,rᵣ,θᵣ,φᵣ)) which can be approximated by various time-frequency transformations, such as the discrete Fourier transform (DFT), the discrete cosine transform (DCT), or a wavelet transform. Other examples of hierarchical sets include sets of wavelet transform coefficients and other sets of coefficients of multiresolution basis functions.

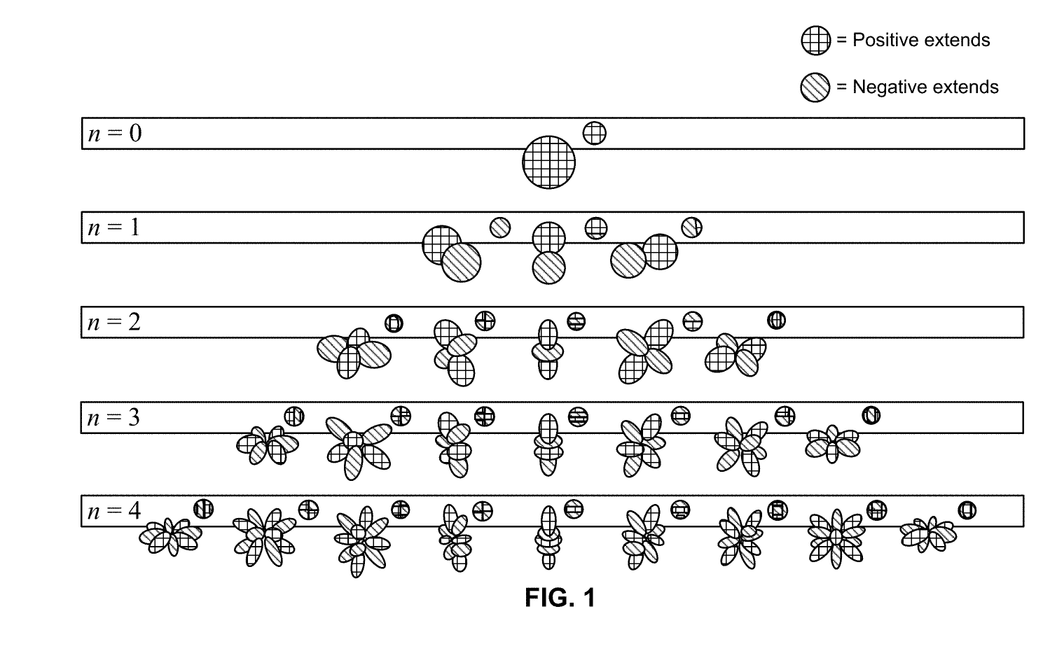

FIG. 1 is a diagram illustrating spherical harmonic basis functions from the zero order (n=0) to the fourth order (n=4). As can be seen, for each order, there is an expansion of suborders m which are shown but not explicitly noted in the example of FIG. 1 for ease of illustration purposes.

The SHC Aₙ^{m}(k) can either be physically acquired (e.g., recorded) by various microphone array configurations or, alternatively, they can be derived from channel-based or object-based descriptions of the soundfield. The SHC (which also may be referred to as higher order ambisonic—HOA—coefficients) represent scene-based audio, where the SHC may be input to an audio encoder to obtain encoded SHC that may promote more efficient transmission or storage. For example, a fourth-order representation involving (1+4)² (25, and hence fourth order) coefficients may be used.

As noted above, the SHC may be derived from a microphone recording using a microphone array. Various examples of how SHC may be derived from microphone arrays are described in Poletti, M., “Three-Dimensional Surround Sound Systems Based on Spherical Harmonics,” J. Audio Eng. Soc., Vol. 53, No. 11, 2005 November, pp. 1004-1025.

To illustrate how the SHCs may be derived from an object-based description, consider the following equation. The coefficients Aₙ^{m}(k) for the soundfield corresponding to an individual audio object may be expressed as:

Aₙ^{m}(k)=g(ω)(−4πik)hₙ⁽²⁾(krₛ)Yₙm*(θₛ,φₛ),

where i is \sqrt{−1}, hₙ⁽²⁾(⋅) is the spherical Hankel function (of the second kind) of order n, and {rₛ,θₛ,φₛ} is the location of the object. Knowing the object source energy g(ω) as a function of frequency (e.g., using time-frequency analysis techniques, such as performing a fast Fourier transform on the PCM stream) allows us to convert each PCM object and the corresponding location into the SHC Aₙ^{m}(k). Further, it can be shown (since the above is a linear and orthogonal decomposition) that the Aₙ^{m}(k) coefficients for each object are additive. In this manner, a number of PCM objects can be represented by the Aₙ^{m}(k) coefficients (e.g., as a sum of the coefficient vectors for the individual objects). Essentially, the coefficients contain information about the soundfield (the pressure as a function of 3D coordinates), and the above represents the transformation from individual objects to a representation of the overall soundfield, in the vicinity of the observation point {rᵣ,θᵣ,φᵣ}. The remaining figures are described below in the context of SHC-based audio coding.

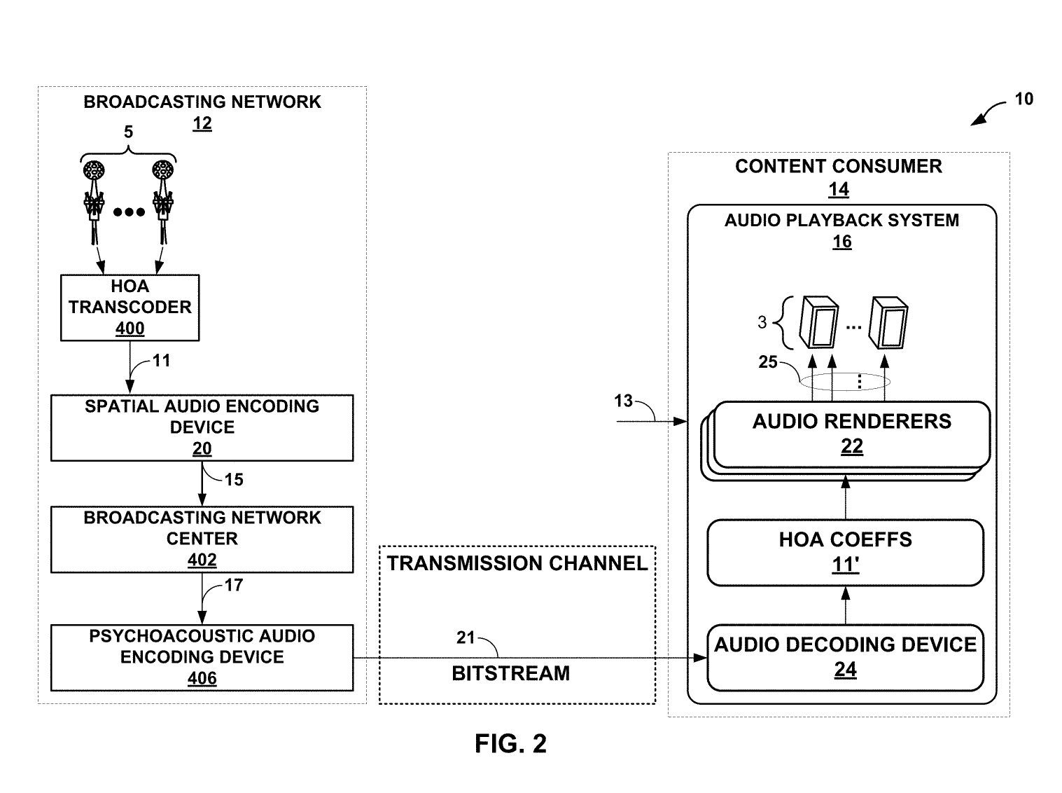

FIG. 2 is a diagram illustrating a system 10 that may perform various aspects of the techniques described in this disclosure. As shown in the example of FIG. 2, the system 10 includes a broadcasting network 12 and a content consumer 14. While described in the context of the broadcasting network 12 and the content consumer 14, the techniques may be implemented in any context in which SHCs (which may also be referred to as HOA coefficients) or any other hierarchical representation of a soundfield are encoded to form a bitstream representative of the audio data. Moreover, the broadcasting network 12 may represent a system comprising one or more of any form of computing devices capable of implementing the techniques described in this disclosure, including a handset (or cellular phone, including a so-called “smart phone”), a tablet computer, a laptop computer, a desktop computer, or dedicated hardware to provide a few examples or. Likewise, the content consumer 14 may represent any form of computing device capable of implementing the techniques described in this disclosure, including a handset (or cellular phone, including a so-called “smart phone”), a tablet computer, a television, a set-top box, a laptop computer, a gaming system or console, or a desktop computer to provide a few examples.

The broadcasting network 12 may represent any entity that may generate multi-channel audio content and possibly video content for consumption by content consumers, such as the content consumer 14. The broadcasting network 12 may capture live audio data at events, such as sporting events, while also inserting various other types of additional audio data, such as commentary audio data, commercial audio data, intro or exit audio data and the like, into the live audio content.

The content consumer 14 represents an individual that owns or has access to an audio playback system, which may refer to any form of audio playback system capable of rendering higher order ambisonic audio data (which includes higher order audio coefficients that, again, may also be referred to as spherical harmonic coefficients) for play back as multi-channel audio content. The higher-order ambisonic audio data may be defined in the spherical harmonic domain and rendered or otherwise transformed form the spherical harmonic domain to a spatial domain, resulting in the multi-channel audio content. In the example of FIG. 2, the content consumer 14 includes an audio playback system 16.

The broadcasting network 12 includes microphones 5 that record or otherwise obtain live recordings in various formats (including directly as HOA coefficients) and audio objects. When the microphone array 5 (which may also be referred to as “microphones 5”) obtains live audio directly as HOA coefficients, the microphones 5 may include an HOA transcoder, such as an HOA transcoder 400 shown in the example of FIG. 2. In other words, although shown as separate from the microphones 5, a separate instance of the HOA transcoder 400 may be included within each of the microphones 5 so as to naturally transcode the captured feeds into the HOA coefficients 11. However, when not included within the microphones 5, the HOA transcoder 400 may transcode the live feeds output from the microphones 5 into the HOA coefficients 11. In this respect, the HOA transcoder 400 may represent a unit configured to transcode microphone feeds and/or audio objects into the HOA coefficients 11. The broadcasting network 12 therefore includes the HOA transcoder 400 as integrated with the microphones 5, as an HOA transcoder separate from the microphones 5 or some combination thereof.

The broadcasting network 12 may also include a spatial audio encoding device 20, a broadcasting network center 402 (which may also be referred to as a “network operations center—NOC—402) and a psychoacoustic audio encoding device 406. The spatial audio encoding device 20 may represent a device capable of performing the mezzanine compression techniques described in this disclosure with respect to the HOA coefficients 11 to obtain intermediately formatted audio data 15 (which may also be referred to as “mezzanine formatted audio data 15”). Intermediately formatted audio data 15 may represent audio data that conforms with an intermediate audio format (such as a mezzanine audio format). As such, the mezzanine compression techniques may also be referred to as intermediate compression techniques.

The spatial audio encoding device 20 may be configured to perform this intermediate compression (which may also be referred to as “mezzanine compression”) with respect to the HOA coefficients 11 by performing, at least in part, a decomposition (such as a linear decomposition, including a singular value decomposition, eigenvalue decomposition, KLT, etc.) with respect to the HOA coefficients 11. Furthermore, the spatial audio encoding device 20 may perform the spatial encoding aspects (excluding the psychoacoustic encoding aspects) to generate a bitstream conforming to the above referenced MPEG-H 3D audio coding standard. In some examples, the spatial audio encoding device 20 may perform the vector-based aspects of the MPEG-H 3D audio coding standard.

The spatial audio encoding device 20 may be configured to encode the HOA coefficients 11 using a decomposition involving application of a linear invertible transform (LIT). One example of the linear invertible transform is referred to as a “singular value decomposition” (or “SVD”), which may represent one form of a linear decomposition. In this example, the spatial audio encoding device 20 may apply SVD to the HOA coefficients 11 to determine a decomposed version of the HOA coefficients 11. The decomposed version of the HOA coefficients 11 may include one or more of predominant audio signals and one or more corresponding spatial components describing a direction, shape, and width of the associated predominant audio signals (which may be referred to in the MPEG-H 3D audio coding standard as a “V-vector”). The spatial audio encoding device 20 may then analyze the decomposed version of the HOA coefficients 11 to identify various parameters, which may facilitate reordering of the decomposed version of the HOA coefficients 11.

The spatial audio encoding device 20 may reorder the decomposed version of the HOA coefficients 11 based on the identified parameters, where such reordering, as described in further detail below, may improve coding efficiency given that the transformation may reorder the HOA coefficients across frames of the HOA coefficients (where a frame commonly includes M samples of the HOA coefficients 11 and M is, in some examples, set to 1024). After reordering the decomposed version of the HOA coefficients 11, the spatial audio encoding device 20 may select those of the decomposed version of the HOA coefficients 11 representative of foreground (or, in other words, distinct, predominant or salient) components of the soundfield. The spatial audio encoding device 20 may specify the decomposed version of the HOA coefficients 11 representative of the foreground components as an audio object (which may also be referred to as a “predominant sound signal,” or a “predominant sound component”) and associated directional information (which may also be referred to as a spatial component).

The spatial audio encoding device 20 may next perform a soundfield analysis with respect to the HOA coefficients 11 in order to, at least in part, identify the HOA coefficients 11 representative of one or more background (or, in other words, ambient) components of the soundfield. The spatial audio encoding device 20 may perform energy compensation with respect to the background components given that, in some examples, the background components may only include a subset of any given sample of the HOA coefficients 11 (e.g., such as those corresponding to zero and first order spherical basis functions and not those corresponding to second or higher order spherical basis functions). When order-reduction is performed, in other words, the spatial audio encoding device 20 may augment (e.g., add/subtract energy to/from) the remaining background HOA coefficients of the HOA coefficients 11 to compensate for the change in overall energy that results from performing the order reduction.

The spatial audio encoding device 20 may perform a form of interpolation with respect to the foreground directional information and then perform an order reduction with respect to the interpolated foreground directional information to generate order reduced foreground directional information. The spatial audio encoding device 20 may further perform, in some examples, a quantization with respect to the order reduced foreground directional information, outputting coded foreground directional information. In some instances, this quantization may comprise a scalar/entropy quantization. The spatial audio encoding device 20 may then output the mezzanine formatted audio data 15 as the background components, the foreground audio objects, and the quantized directional information. The background components and the foreground audio objects may comprise pulse code modulated (PCM) transport channels in some examples.

The spatial audio encoding device 20 may then transmit or otherwise output the mezzanine formatted audio data 15 to the broadcasting network center 402. Although not shown in the example of FIG. 2, further processing of the mezzanine formatted audio data 15 may be performed to accommodate transmission from the spatial audio encoding device 20 to the broadcasting network center 402 (such as encryption, satellite compression schemes, fiber compression schemes, etc.).

Mezzanine formatted audio data 15 may represent audio data that conforms to a so-called mezzanine format, which is typically a lightly compressed (relative to end-user compression provided through application of psychoacoustic audio encoding to audio data, such as MPEG surround, MPEG-AAC, MPEG-USAC or other known forms of psychoacoustic encoding) version of the audio data. Given that broadcasters prefer dedicated equipment that provides low latency mixing, editing, and other audio and/or video functions, broadcasters are reluctant to upgrade the equipment given the cost of such dedicated equipment.

To accommodate the increasing bitrates of video and/or audio and provide interoperability with older or, in other words, legacy equipment that may not be adapted to work on high definition video content or 3D audio content, broadcasters have employed this intermediate compression scheme, which is generally referred to as “mezzanine compression,” to reduce file sizes and thereby facilitate transfer times (such as over a network or between devices) and improved processing (especially for older legacy equipment). In other words, this mezzanine compression may provide a more lightweight version of the content which may be used to facilitate editing times, reduce latency and potentially improve the overall broadcasting process.

The broadcasting network center 402 may therefore represent a system responsible for editing and otherwise processing audio and/or video content using an intermediate compression scheme to improve the work flow in terms of latency. The broadcasting network center 402 may, in some examples, include a collection of mobile devices. In the context of processing audio data, the broadcasting network center 402 may, in some examples, insert intermediately formatted additional audio data into the live audio content represented by the mezzanine formatted audio data 15. This additional audio data may comprise commercial audio data representative of commercial audio content (including audio content for television commercials), television studio show audio data representative of television studio audio content, intro audio data representative of intro audio content, exit audio data representative of exit audio content, emergency audio data representative of emergency audio content (e.g., weather warnings, national emergencies, local emergencies, etc.) or any other type of audio data that may be inserted into mezzanine formatted audio data 15.

In some examples, the broadcasting network center 402 includes legacy audio equipment capable of processing up to 16 audio channels. In the context of 3D audio data that relies on HOA coefficients, such as the HOA coefficients 11, the HOA coefficients 11 may have more than 16 audio channels (e.g., a 4th order representation of the 3D soundfield would require (4+1)² or 25 HOA coefficients per sample, which is equivalent to 25 audio channels). This limitation in legacy broadcasting equipment may slow adoption of 3D HOA-based audio formats, such as that set forth in the ISO/IEC DIS 23008-3:201x(E) document, entitled “Information technology—High efficiency coding and media delivery in heterogeneous environments—Part 3: 3D audio,” by ISO/IEC JTC 1/SC 29/WG 11, dated 2016 Oct. 12 (which may be referred to herein as the “3D Audio Coding Standard”).

As such, the mezzanine compression allows for obtaining the mezzanine formatted audio data 15 from the HOA coefficients 11 in a manner that overcomes the channel-based limitations of legacy audio equipment. That is, the spatial audio encoding device 20 may be configured to obtain the mezzanine audio data 15 having 16 or fewer audio channels (and possibly as few as 6 audio channels given that legacy audio equipment may, in some examples, allow for processing 5.1 audio content, where the ‘0.1’ represents the sixth audio channel).

The broadcasting network center 402 may output updated mezzanine formatted audio data 17. The updated mezzanine formatted audio data 17 may include the mezzanine formatted audio data 15 and any additional audio data inserted into the mezzanine formatted audio data 15 by the broadcasting network center 404. Prior to distribution, the broadcasting network 12 may further compress the updated mezzanine formatted audio data 17. As shown in the example of FIG. 2, the psychoacoustic audio encoding device 406 may perform psychoacoustic audio encoding (e.g., any one of the examples described above) with respect to the updated mezzanine formatted audio data 17 to generate a bitstream 21. The broadcasting network 12 may then transmit the bitstream 21 via a transmission channel to the content consumer 14.

In some examples, the psychoacoustic audio encoding device 406 may represent multiple instances of a psychoacoustic audio coder, each of which is used to encode a different audio object or HOA channel of each of updated mezzanine formatted audio data 17. In some instances, this psychoacoustic audio encoding device 406 may represent one or more instances of an advanced audio coding (AAC) encoding unit. Often, the psychoacoustic audio coder unit 40 may invoke an instance of an AAC encoding unit for each of channel of the updated mezzanine formatted audio data 17.

More information regarding how the background spherical harmonic coefficients may be encoded using an AAC encoding unit can be found in a convention paper by Eric Hellerud, et al., entitled “Encoding Higher Order Ambisonics with AAC,” presented at the 124th Convention, 2008 May 17-20 and available at: http://ro.uow.edu.au/cgi/viewcontent.cgi?article=8025&context=engpapers. In some instances, the psychoacoustic audio encoding device 406 may audio encode various channels (e.g., background channels) of the updated mezzanine formatted audio data 17 using a lower target bitrate than that used to encode other channels (e.g., foreground channels) of the updated mezzanine formatted audio data 17.

While shown in FIG. 2 as being directly transmitted to the content consumer 14, the broadcasting network 12 may output the bitstream 21 to an intermediate device positioned between the broadcasting network 12 and the content consumer 14. The intermediate device may store the bitstream 21 for later delivery to the content consumer 14, which may request this bitstream. The intermediate device may comprise a file server, a web server, a desktop computer, a laptop computer, a tablet computer, a mobile phone, a smart phone, or any other device capable of storing the bitstream 21 for later retrieval by an audio decoder. The intermediate device may reside in a content delivery network capable of streaming the bitstream 21 (and possibly in conjunction with transmitting a corresponding video data bitstream) to subscribers, such as the content consumer 14, requesting the bitstream 21.

Alternatively, the broadcasting network 12 may store the bitstream 21 to a storage medium, such as a compact disc, a digital video disc, a high definition video disc or other storage media, most of which are capable of being read by a computer and therefore may be referred to as computer-readable storage media or non-transitory computer-readable storage media. In this context, the transmission channel may refer to those channels by which content stored to these mediums are transmitted (and may include retail stores and other store-based delivery mechanism). In any event, the techniques of this disclosure should not therefore be limited in this respect to the example of FIG. 2.

As further shown in the example of FIG. 2, the content consumer 14 includes the audio playback system 16. The audio playback system 16 may represent any audio playback system capable of playing back multi-channel audio data. The audio playback system 16 may include a number of different audio renderers 22. The audio renderers 22 may each provide for a different form of rendering, where the different forms of rendering may include one or more of the various ways of performing vector-base amplitude panning (VBAP), and/or one or more of the various ways of performing soundfield synthesis.

The audio playback system 16 may further include an audio decoding device 24. The audio decoding device 24 may represent a device configured to decode HOA coefficients 11′ from the bitstream 21, where the HOA coefficients 11′ may be similar to the HOA coefficients 11 but differ due to lossy operations (e.g., quantization) and/or transmission via the transmission channel.

That is, the audio decoding device 24 may dequantize the foreground directional information specified in the bitstream 21, while also performing psychoacoustic decoding with respect to the foreground audio objects specified in the bitstream 21 and the encoded HOA coefficients representative of background components. The audio decoding device 24 may further perform interpolation with respect to the decoded foreground directional information and then determine the HOA coefficients representative of the foreground components based on the decoded foreground audio objects and the interpolated foreground directional information. The audio decoding device 24 may then determine the HOA coefficients 11′ based on the determined HOA coefficients representative of the foreground components and the decoded HOA coefficients representative of the background components.

The audio playback system 16 may, after decoding the bitstream 21 to obtain the HOA coefficients 11′, render the HOA coefficients 11′ to output loudspeaker feeds 25. The audio playback system 15 may output loudspeaker feeds 25 to one or more of loudspeakers 3. The loudspeaker feeds 25 may drive one or more loudspeakers 3.

To select the appropriate renderer or, in some instances, generate an appropriate renderer, the audio playback system 16 may obtain loudspeaker information 13 indicative of a number of the loudspeakers 3 and/or a spatial geometry of the loudspeakers 3. In some instances, the audio playback system 16 may obtain the loudspeaker information 13 using a reference microphone and driving the loudspeakers 3 in such a manner as to dynamically determine the loudspeaker information 13. In other instances or in conjunction with the dynamic determination of the loudspeaker information 13, the audio playback system 16 may prompt a user to interface with the audio playback system 16 and input the loudspeaker information 13.

The audio playback system 16 may select one of the audio renderers 22 based on the loudspeaker information 13. In some instances, the audio playback system 16 may, when none of the audio renderers 22 are within some threshold similarity measure (in terms of the loudspeaker geometry) to that specified in the loudspeaker information 13, generate the one of audio renderers 22 based on the loudspeaker information 13. The audio playback system 16 may, in some instances, generate the one of audio renderers 22 based on the loudspeaker information 13 without first attempting to select an existing one of the audio renderers 22.

While described with respect to loudspeaker feeds 25, the audio playback system 16 may render headphone feeds from either the loudspeaker feeds 25 or directly from the HOA coefficients 11′, outputting the headphone feeds to headphone speakers. The headphone feeds may represent binaural audio speaker feeds, which the audio playback system 15 renders using a binaural audio renderer.

As noted above, the spatial audio encoding device 20 may analyze the soundfield to select a number of HOA coefficients (such as those corresponding to spherical basis functions having an order of one or less) to represent an ambient component of the soundfield. The spatial audio encoding device 20 may also, based on this or another analysis, select a number of predominant audio signals and corresponding spatial components to represent various aspects of a foreground component of the soundfield, discarding any remaining predominant audio signals and corresponding spatial components.

In an attempt to reduce bandwidth consumption, the spatial audio encoding device 20 may remove information that is redundantly expressed in both the selected subset of the HOA coefficients used to represent the background (or, in other words, ambient) component of the soundfield (where such HOA coefficients may also be referred to as “ambient HOA coefficients”) and the selected combinations of the predominate audio signals and the corresponding spatial components. For example, the selected subset of the HOA coefficients may include the HOA coefficients corresponding to spherical basis functions having a first and zeroeth order. The selected spatial components, which are also defined in the spherical harmonic domain, may also include elements that correspond to spherical basis functions having the first and zeroeth order. As such, the spatial audio encoding device 20 may remove the elements of the spatial component associated with the spherical basis functions having the first and zeroeth order. More information regarding the removal of elements of the spatial component (which may also be referred to as a “predominant vector”) can be found in the MPEG-H 3D Audio Coding Standard, at section 12.4.1.11.2, entitled (“VVecLength and VVecCoeffId”) on page 380.

As another example, the spatial audio encoding device 20 may remove those of the selected subset of the HOA coefficients that providing information duplicative of (or, in other words, redundant in comparison to) the combination of the predominant audio signals and the corresponding spatial components. That is, the predominant audio signals and the corresponding spatial components may include the same or similar information to one or more of the selected subset of the HOA coefficients used to represent the background component of the soundfield. As such, the spatial audio encoding device 20 may remove one or more of the selected subset of the HOA coefficients 11 from mezzaning formatted audio data 15. More information regarding the removal of HOA coefficients from the selected subset of the HOA coefficients 11 can be found in the 3D Audio Coding Standard at section 12.4.2.4.4.2 (e.g., the last paragraph), Table 196 on page 351.

The various reductions of redundant information may improve overall compression efficiency, but may result in loss of fidelity when such reductions are performed without access to certain information. In the context of FIG. 2, the spatial audio encoding device 20 (which may also be referred to as “mezzanine encoder 20” or “ME 20”) may remove the redundant information that will be necessary in certain contexts for the psychoacoustic audio encoding device 406 (which may also be referred to as “emission encoder 20” or “EE 20”) to properly encode the HOA coefficients 11 for transmission (or, in other words, emission) to the content consumer 14.

To illustrate, consider that the emission encoder 406 may transcode the updated mezzanine formatted audio data 17 based on a target bitrate to which the mezzanine encoder 20 does not have access. The emission encoder 406 may, to achieve the target bitrate, transcode the updated mezzanine formatted audio data 17 and reduce the number of predominant audio signals from, as one example, four predominant audio signals to two predominant audio signals. When the ones of the predominant audio signals removed by the emission encoder 406 provided information allowing for the removal of one or more of the ambient HOA coefficients, the removal by the emission encoder 406 of the predominant audio signals may result in unrecoverable loss of the ambient HOA coefficients, which at best potentially degrades the quality of reproduction of the ambient component of the soundfield, and at worst prevents reconstruction and playback of the soundfield because the bitstream 21 cannot be decoded (due to not conforming to the 3D Audio Coding Standard).

Furthermore, the emission encoder 406 may, again to achieve the target bitrate, reduce the number of ambient HOA coefficients from the, as one example, nine ambient HOA coefficients corresponding to spherical basis functions having an order of two, one, and zero provided by the updated mezzanine formatted audio data 17 to four ambient HOA coefficients corresponding to the spherical basis functions having an order of one and zero. The transcoding of updated mezzanine formatted audio data 17 to generate the bitstream 21 having only four ambient HOA coefficients coupled with the removal by the mezzanine encoder 20 of the nine elements of the spatial component corresponding to the spherical basis functions having an order of two, one, and zero results in an unrecoverable loss of spatial characteristics for the corresponding predominant audio signal.

That is, the mezzanine encoder 20 relied on the nine ambient HOA coefficients to provide the lower order representation of the predominant components of the soundfield, using the predominant audio signals and corresponding spatial component to provide the higher-order representation of the predominant components of the soundfield. When the emission encoder 406 removes one or more of the ambient HOA coefficients (i.e., the five ambient HOA coefficients corresponding to the spherical basis function having an order of two in the above example), the emission encoder 406 cannot add back in the removed elements of the spatial component previously deemed redundant but now necessary to fill in the information for the removed ambient HOA coefficients. As such, the removal by the emission encoder 406 of one or more the ambient HOA coefficients may result in unrecoverable loss of the elements of the spatial component, which at best potentially degrades the quality of reproduction of the foreground component of the soundfield, and at worst prevents reconstruction and playback of the soundfield because bitstream 21 cannot be decoded (due to not conforming to the 3D Audio Coding Standard).

In accordance with the techniques described in this disclosure, the mezzanine encoder 20 may, rather than remove the redundant information, include the redundant information in the mezzanine formatted audio data 15 to allow the emission encoder 406 to successfully transcode the updated mezzanine formatted audio data 17 in the manner described above. The mezzanine encoder 20 may disable or otherwise not implement the various coding modes related to the removal of the redundant information and thereby include all such redundant information. As such, the mezzanine encoder 20 may form what may be considered a scalable version of the mezzanine formatted audio data 15 (which may be referred to as “scalable mezzanine formatted audio data 15”).

The scalable mezzanine formatted audio data 15 may be “scalable” in the sense that any layer may be extracted and form a basis for forming the bitstream 21. One layer for example may include any combination of the ambient HOA coefficients and/or the predominant audio signals/corresponding spatial components. By disabling removal of redundant information with the result of forming the scalable mezzanine audio data 15, the emission encoder 406 may select any combination of layers and form the bitstream 21 that may achieve the target bitrate while also conforming to the 3D Audio Coding Standard.

In operation, the mezzanine encoder 20 may decompose (e.g., by applying one of the linear invertible transforms described above to) the HOA coefficients 11 representative of the soundfield into a predominant sound component (e.g., the below described audio objects 33) and a corresponding spatial component (e.g., the below described V vectors 35). As noted above, the corresponding spatial component is representative of the directions, shape, and width of the predominant sound component, while also being defined in the spherical harmonic domain.

The mezzanine encoder 20 may specify, in a bitstream 15 conforming to an intermediate compression format (which may also be referred to as “scalable mezzanine formatted audio data 15”), a subset of the higher order ambisonic coefficients 11 that represent an ambient component of the soundfield (which also may be referred to as noted above as the “ambient HOA coefficients”). The mezzanine encoder 20 may also specify, in the bitstream 15, all elements of the spatial component despite that at least one of the elements of the spatial component includes information that is redundant with respect to information provided by the ambient HOA coefficients.

In conjunction with or as an alternative to the foregoing operation, the mezzanine encoder 20 may also, after performing the above noted decomposition, specify, in the bitstream 15 conforming to the intermediate compression format, the predominant audio signal. The mezzanine encoder 20 may next specify, in the bitstream 15, the ambient higher order ambisonic coefficients despite that at least one of the ambient higher order ambisonic coefficients includes information that is redundant with respect to information provided by the predominant audio signal and the corresponding spatial component.

The changes to the mezzanine encoder 20 may be reflected by comparing the following two tables, with Table 1 showing the previous operation and Table 2 showing operation consistent with the aspects of the techniques described in this disclosure.

TABLE 1
Previous Operation

| | 0 | 4 | 9 |
|---|---|---|---|
| 0 | H_BG = H − | H_BG = H − | H_BG = H − |
| | H_FG | H_FG | H_FG |
| | Full V vectors | Full V vectors | Full V vectors |
| | decorrMethod = | decorrMethod = | decorrMethod = |
| | don't care | 1 (1~4) | 1 (1~9) |
| 1 | H_BG = H | H_BG = H | H_BG = H |
| | No V for 1~9 | No V for 1~9 | No V for 1~9 |
| | decorrMethod = | decorrMethod = | decorrMethod = |
| | don't care | 1 (1~4) | 1 (1~9) |
| 2 | H_BG = H − H_FG | H_BG = H for 1~4 | H_BG = H |
| | Full V vectors | H_BG = H − | No V for 1~9 |
| | decorrMethod = | H_FG for 5~9 | decorrMethod = |
| | don't care | No V for 1~4 | 1 (1~9) |
| | | decorrMethod = | |
| | | 1 (1~4) | |

In Table 1, the columns reflect a value determined for a MinNumOfCoeffsForAmbHOA syntax element set forth in the 3D Audio Coding Standard, while the rows reflect a value determined for a CodedVVecLength syntax element set forth in the 3D Audio Coding Standard. The MinNumOFCoeffsForAmbHOA syntax element indicates the minimum number of ambient HOA coefficients. The CodedVVecLength syntax element indicates the length of the transmitted data vector used to synthesize the vector-based signals.

As shown in Table 1, various combinations result in the ambient HOA coefficients (H_BG) being determined by subtracting HOA coefficients used for forming the predominant or foreground component of the soundfield (H_FG) from the HOA coefficients 11 up to a given order (which are shown as “H” in Table 1). Furthermore, as shown in Table 1, various combinations result in the removal of elements (e.g., those indexed as 1-9 or 1-4) for the spatial component (shown as “V” in Table 1).

TABLE 2
Updated Operation

| | 0 | 4 | 9 |
|---|---|---|---|
| 0 | H_BG = H | H_BG = H | H_BG = H |
| | Full V vectors | Full V vectors | Full V vectors |
| | decorrMethod = | decorrMethod = | decorrMethod = |
| | 1 | 1 (1~4) | 1 (1~9) |
| 1 | H_BG = H | H_BG = H | H_BG = H |
| | Full V vectors | Full V vectors | Full V vectors |
| | decorrMethod = | decorrMethod = | decorrMethod = |
| | 1 | 1 (1~4) | 1 (1~9) |
| 2 | H_BG = H | H_BG = H | H_BG = H |
| | Full V vectors | Full V vectors | Full V vectors |
| | decorrMethod = | decorrMethod = | decorrMethod = |
| | 1 | 1 (1~4) | 1 (1~9) |

In Table 2, the columns reflect a value determined for a MinNumOfCoeffsForAmbHOA syntax element set forth in the 3D Audio Coding Standard, while the rows reflect a value determined for a CodedVVecLength syntax element set forth in the 3D Audio Coding Standard. Irrespective of the values determined for the MinNumOfCoeffsForAmbHOA and CodedVVecLength syntax elements, the mezzanine encoder 20 may determine the ambient HOA coefficients as the subset of the HOA coefficients 11 associated with a spherical basis function having a minimum order and less are to be specified in the bitstream 15. In some example, the minimum order is two, resulting in a fixed number of nine ambient HOA coefficients. In these and other examples, the minimum order is one, resulting in a fixed number of four ambient HOA coefficients.

Irrespective of the values determined for the MinNumOfCoeffsForAmbHOA and CodedVVecLength syntax elements, the mezzanine encoder 20 may also determine that all of the elements of the spatial component is to be specified in the bitstream 15. In both instances, the mezzanine encoder 20 may specify redundant information as described above, resulting in scalable mezzanine formatted audio data 15 that allows for a downstream encoder, i.e., the emission encoder 406 in the example of FIG. 2, to generate a bitstream 21 conforming to the 3D Audio Coding Standard.

As further shown in the above Tables 1 and 2, the mezzanine encoder 20 may disable decorrelation (as shown by “No decorrMethod”) from being applied to the ambient HOA coefficients irrespective of the values determined for the MinNumOfCoeffsForAmbHOA and CodedVVecLength syntax elements. The mezzanine encoder 20 may apply decorrelation to the ambient HOA coefficients in an effort to decorrelate the different coefficients of the ambient HOA coefficients so as to improve psychoacoustic audio encoding (where the different coefficients are temporally predicted from one another and thereby benefit, in terms of the extent of compression achievable, by being decorrelated). More information regarding decorrelation of ambieng HOA coefficients can be found in U.S. Patent Publication No. 2016/007132, entitled “REDUCING CORRELATION BETWEEN HIGHER ORDER AMBISONIC (HOA) BACKGROUND CHANNELS,” filed Jul. 1, 2015. As such, the mezzanine encoder 20 may specify, in the bitstream 15 and without applying decorrelation to the ambient HOA coefficients, each of the ambient HOA coefficients in the dedicated ambient channel of the bitstream 15.

The mezzanine encoder 20 may specify, in bitstream 15 conforming to an intermediate compression format, a subset of the higher order ambisonic coefficients 11 that represent a background component of the soundfield (e.g., the ambient HOA coefficients 47) with each of the different ambient HOA coefficients as a different channel in the bitstream 15. The mezzanine encoder 20 may select a fixed number of the HOA coefficients 11 to be the ambient HOA coefficients. When nine of the HOA coefficients 11 are selected to be the ambient HOA coefficients, the mezzanine encoder 20 may specify each of the nine ambient HOA coefficients in a separate channel of the bitstream 15 (resulting in nine channels in total to specify the nine ambient HOA coefficients).

The mezzanine encoder 20 may also specify, in the bitstream 15, all elements of the coded spatial components with all of the spatial components 57 in a single side information channel of the bitstream 15. The mezzanine encoder 20 may further specify, in a separate foreground channel of the bitstream 15, each of the predominant audio signals.

The mezzanine encoder 20 may specify additional parameters in each Access Unit of the bitstream (where an Access Unit may represent a frame of audio data, which may include, as one example, 1024 audio samples). The additional parameters may include an HOA order (which may, as one example, be specified using 6 bits), an isScreenRelative syntax element that indicates whether an object position is screen-relative, an usesNFC syntax element that indicates whether or not HOA near field compensation (NFC) has been applied of the coded signal, an NFCReferenceDistance syntax element that indicates a radius in meters that has been used for the HOA NFC (which may be interpreted as a float in IEEE 754 format in little-endian), an Ordering syntax element indicating whether the HOA coefficients are ordered in the Ambisonic Channel Numbering (ACN) order or the Single Index Designation (SID) order, and a normalization syntax element that indicates whether full three-dimensional normalization (N3D) or semi-three-dimensional normalization (SN3D) was applied.

The additional parameters may also include a minNumOfCoeffsForAmbHOA syntax element, for example, set to a value of zero or a MinAmbHoaOrder syntax element, for example, set to negative one, a singleLayer syntax element set to a value of one (to indicate that the HOA signal is provided using a single layer), a CodedSpatialInterpolationTime syntax element set to a value of 512 (indicating a time of the spatio-temporal interpolation of the vector-based directional signals—e.g., the above referenced V vectors—as defined in Table 209 of the 3D Audio Coding Standard), a SpatialInterpolationMethod syntax element set to a value of zero (which indicates a type of spatial interpolation applied to the vector-based directional signals), a codedVVecLength syntax element set to a value of one (indicating that all elements of the spatial components are specified). Furthermore, the additional parameters may include a maxGainCorrAmpExp syntax element set to a value of two, an HOAFrameLengthIndicator syntax element set to a value of 0, 1, or 2 (indicating that the frame length is 1024 samples if outputFrameLength=1024), a maxHOAOrderToBeTransmitted syntax element set to a value of three (where this syntax element indicates the maximum HOA order of the additional ambient HOA coefficients to be transmitted), a NumVvecIndicies syntax element set to a value of eight, and a decorrMethod syntax element set to a value of one (indicating that no decorrelation was applied).

The mezzanine encoder 20 may also specify, in the bitstream 15, an hoaIndependencyFlag syntax element set to a value of one (indicating that the current frame is an independent frame that can be decoded without having access to a previous frame in coding order), an nbitsQ syntax element set to a value of five (indicating that the spatial components are uniform 8-bit scalar quantized), a number of predominant sound components syntax element set to a value of four (indicating that four predominant sound components are specified in the bitstream 15, and a number of ambient HOA coefficients syntax element set to a value of nine (indicating that the number of ambient HOA coefficients included in the bitstream 15 is nine).

In this way, the mezzanine encoder 20 may specify scalable mezzanine formatted audio data 15 in such a manner that the emission encoder 406 may successfully transcode the scalable mezzanine formatted audio data 15 to generate the bitstream 21 that conforms with the 3D Audio Coding Standard.

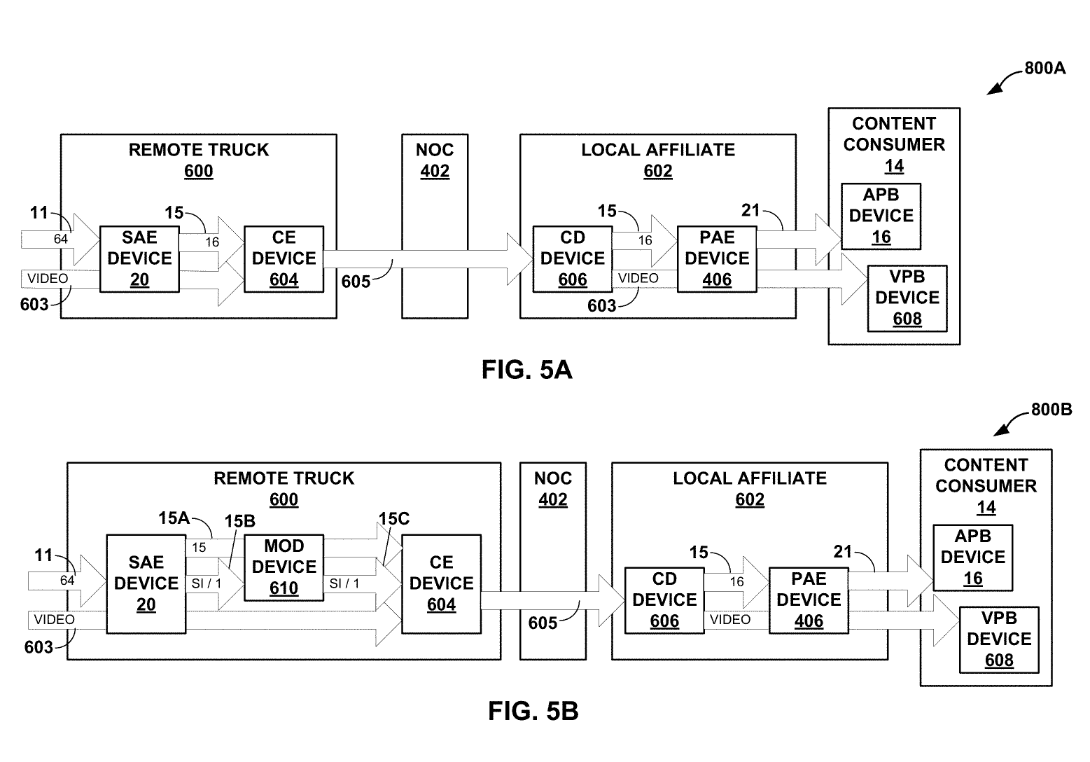

FIGS. 5A and 5B are block diagrams illustrating examples of the system 10 of FIG. 2 in more detail. As shown in the example of FIG. 5A, system 800A is an example of system 10, where system 800A includes a remote truck 600, the network operations center 402, a local affiliate 602, and the content consumer 14. The remote truck 600 includes the spatial audio encoding device 20 (shown as “SAE device 20” in the example of FIG. 5A) and a contribution encoder device 604 (shown as “CE device 604” in the example of FIG. 5A).

The SAE device 20 operates in the manner described above with respect to the spatial audio encoding device 20 described above with respect to the example of FIG. 2. The SAE device 20, as shown in the example of FIG. 5A, receives 64 HOA coefficients 11 and generates the intermediately formatted bitstream 15 including 16 channels—15 channels of predominant audio signals and ambient HOA coefficients, and 1 channel of sideband information defining the spatial components corresponding to the predominant audio signals and adaptive gain control (AGC) information among other sideband information.

The CE device 604 operates with respect to the intermediately formatted bitstream 15 and video data 603 to generate mixed-media bitstream 605. The CE device 604 may perform lightweight compression with respect to intermediately formatted audio data 15 and video data 603 (captured concurrent to the capture of the HOA coefficients 11). The CE device 604 may multiplex frames of the compressed intermediately formatted audio bitstream 15 and the compressed video data 603 to generate the mixed-media bitstream 605. The CE device 604 may transmit the mixed-media bitstream 605 to NOC 402 for further processing as described above.

The local affiliate 602 may represent a local broadcasting affiliate, which broadcasts the content represented by the mixed-media bitstream 605 locally. The local affiliate 602 may include a contribution decoder device 606 (shown as “CD device 606” in the example of FIG. 5A) and a psychoacoustic audio encoding device 406 (shown as “PAE device 406” in the example of FIG. 5A). The CD device 606 may operate in a manner that is reciprocal to operation of the CE device 604. As such, the CD device 606 may demultiplex the compressed versions of the intermediately formatted audio bitstream 15 and the video data 603 and decompress both the compressed versions of the intermediately formatted audio bitstream 15 and the video data 603 to recover the intermediately formatted bitstream 15 and the video data 603. The PAE device 406 may operate in the manner described above with respect to the psychoacoustic audio encoder device 406 shown in FIG. 2 to output the bitstream 21. The PAE device 406 may be referred to, in the context of broadcasting systems, as an “emission encoder 406.”

The emission encoder 406 may transcode the bitstream 15, updating the hoaIndependencyFlag syntax element depending on whether the emission encoder 406 utilized prediction between audio frames or not, while also potentially changing the value of the number of predominant sound components syntax element, and the value of the number of ambient HOA coefficients syntax element. The emission encoder 406 may change the hoaIndependentFlag syntax element, the number of predominant sound components syntax element and the number of ambient HOA coefficients syntax element to achieve a target bitrate.

Although not shown in the example of FIG. 5A, the local affiliate 602 may include further devices to compress the video data 603. Moreover, although described as being distinct devices (e.g., the SAE device 20, the CE device 604, the CD device 606, the PAE device 406, the APB device 16, and a VPB device 608 described below in more detail, etc.), the various devices may be implemented as distinct units or hardware within one or more devices.

The content consumer 14 shown in the example of FIG. 5A includes the audio playback device 16 described above with respect to the example of FIG. 2 (shown as “APB device 16” in the example of FIG. 5A) and a video playback (VPB) device 608. The APB device 16 may operate as described above with respect to FIG. 2 to generate multi-channel audio data 25 that are output to speakers 3 (which may refer to loudspeakers or speakers integrated into headphones, earbuds, etc.). The VPB device 608 may represent a device configured to playback video data 603, and may include video decoders, frame buffers, displays, and other components configured to playback video data 603.

System 800B shown in the example of FIG. 5B is similar to the system 800A of FIG. 5B except that the remote truck 600 includes an addition device 610 configured to perform modulation with respect to the sideband information 15B of the bitstream 15 (where the other 15 channels are denoted as “channels 15A” or “transport channels 15A”). The additional device 610 is shown in the example of FIG. 5B as “mod device 610.” The modulation device 610 may perform modulation of sideband information 610 to potentially reduce clipping of the sideband information and thereby reduce signal loss.

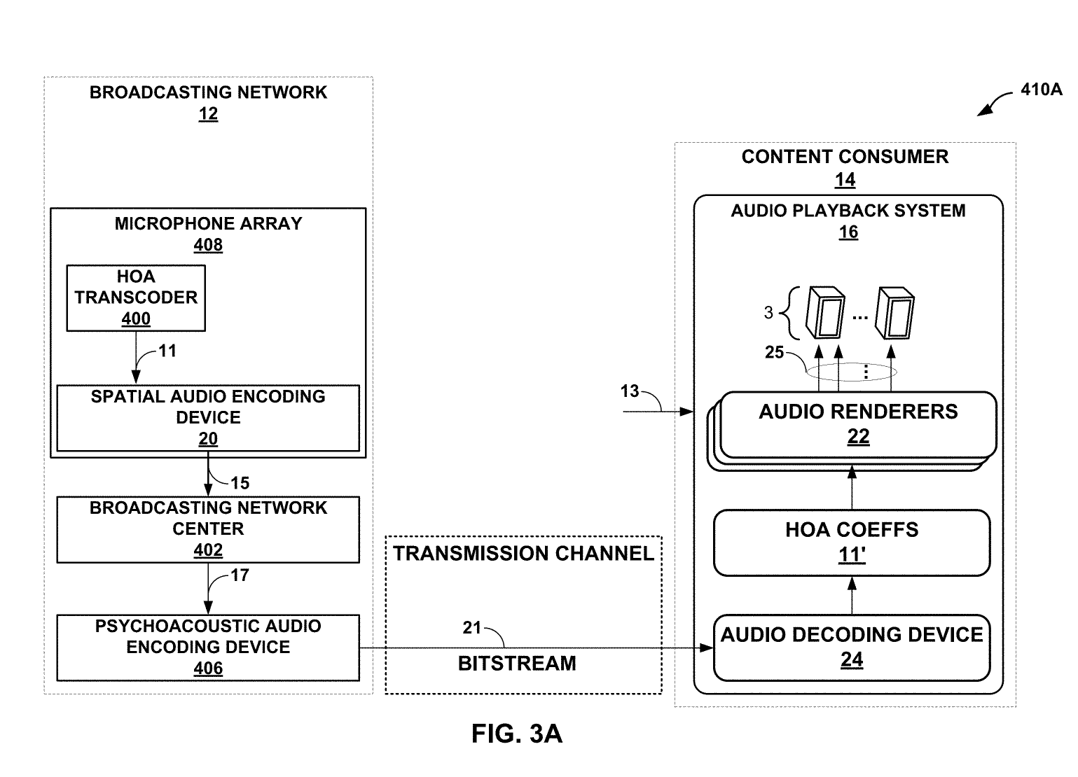

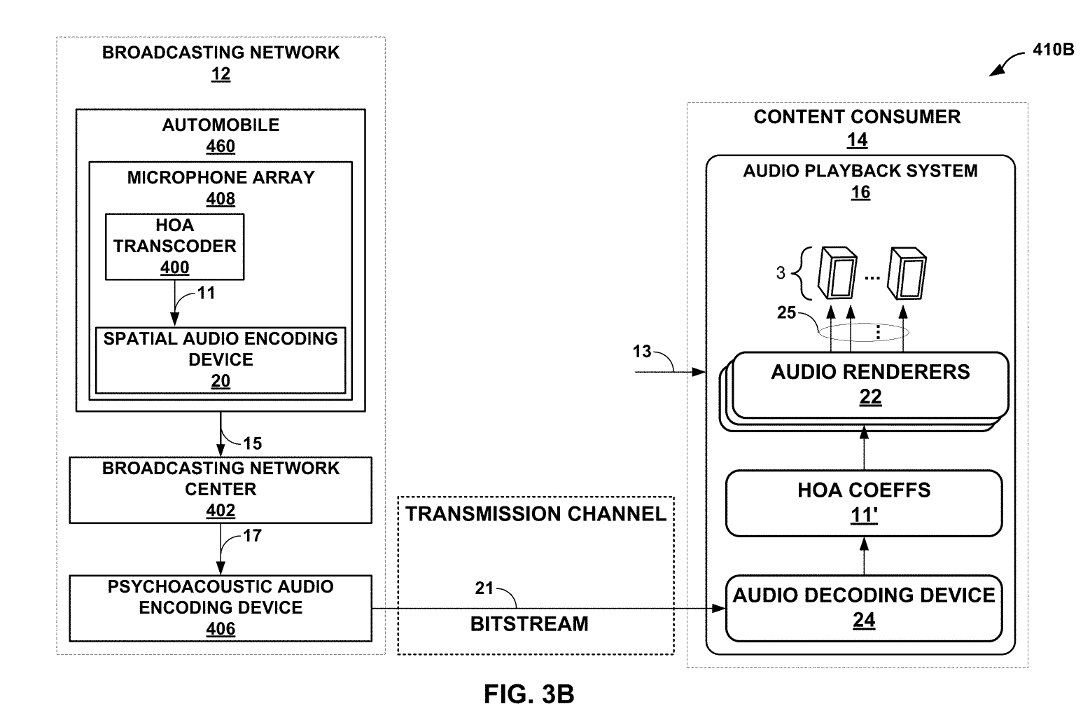

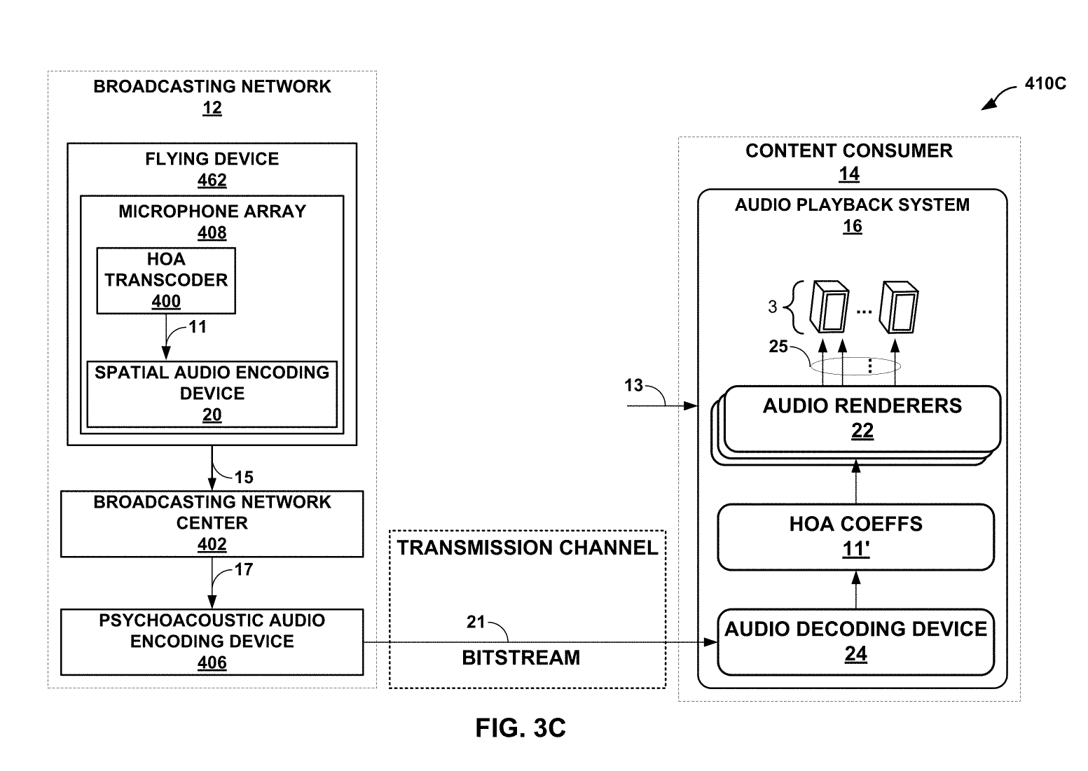

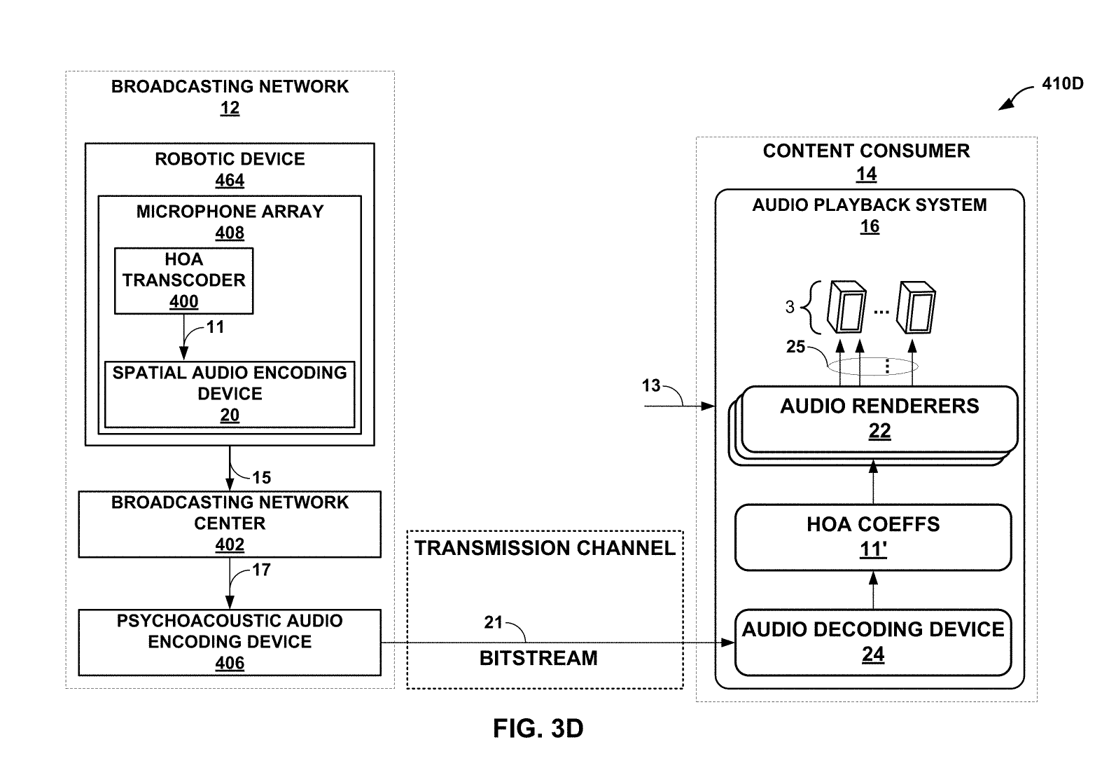

FIGS. 3A-3D are block diagrams illustrating different examples of a system that may be configured to perform various aspects of the techniques described in this disclosure. The system 410A shown in FIG. 3A is similar to the system 10 of FIG. 2, except that the microphone array 5 of the system 10 is replaced with a microphone array 408. The microphone array 408 shown in the example of FIG. 3A includes the HOA transcoder 400 and the spatial audio encoding device 20. As such, the microphone array 408 generates the spatially compressed HOA audio data 15, which is then compressed using the bitrate allocation in accordance with various aspects of the techniques set forth in this disclosure.

The system 410B shown in FIG. 3B is similar to the system 410A shown in FIG. 3A except that an automobile 460 includes the microphone array 408. As such, the techniques set forth in this disclosure may be performed in the context of automobiles.

The system 410C shown in FIG. 3C is similar to the system 410A shown in FIG. 3A except that a remotely-piloted and/or autonomous controlled flying device 462 includes the microphone array 408. The flying device 462 may for example represent a quadcopter, a helicopter, or any other type of drone. As such, the techniques set forth in this disclosure may be performed in the context of drones.

The system 410D shown in FIG. 3D is similar to the system 410A shown in FIG. 3A except that a robotic device 464 includes the microphone array 408. The robotic device 464 may for example represent a device that operates using artificial intelligence, or other types of robots. In some examples, the robotic device 464 may represent a flying device, such as a drone. In other examples, the robotic device 464 may represent other types of devices, including those that do not necessarily fly. As such, the techniques set forth in this disclosure may be performed in the context of robots.

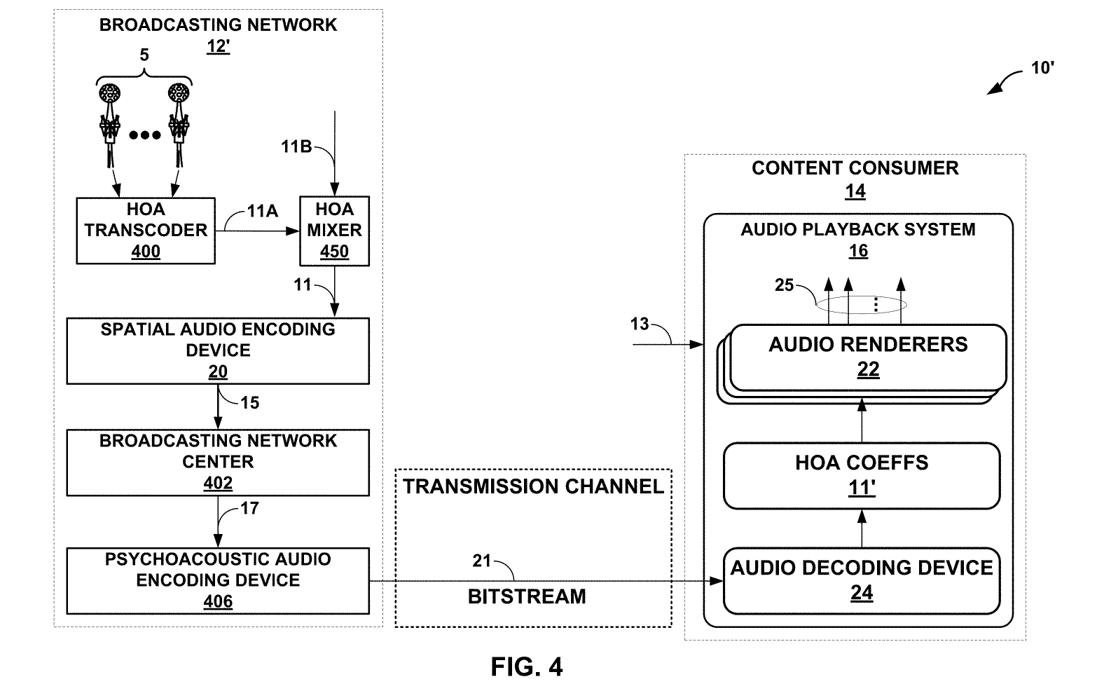

FIG. 4 is a block diagram illustrating another example of a system that may be configured to perform various aspects of the techniques described in this disclosure. The system shown in FIG. 4 is similar to the system 10 of FIG. 2 except that the broadcasting network 12 includes an additional HOA mixer 450. As such, the system shown in FIG. 4 is denoted as system 10′ and the broadcast network of FIG. 4 is denoted as broadcast network 12′. The HOA transcoder 400 may output the live feed HOA coefficients as HOA coefficients 11A to the HOA mixer 450. The HOA mixer represents a device or unit configured to mix HOA audio data. HOA mixer 450 may receive other HOA audio data 11B (which may be representative of any other type of audio data, including audio data captured with spot microphones or non-3D microphones and converted to the spherical harmonic domain, special effects specified in the HOA domain, etc.) and mix this HOA audio data 11B with HOA audio data 11A to obtain HOA coefficients 11.

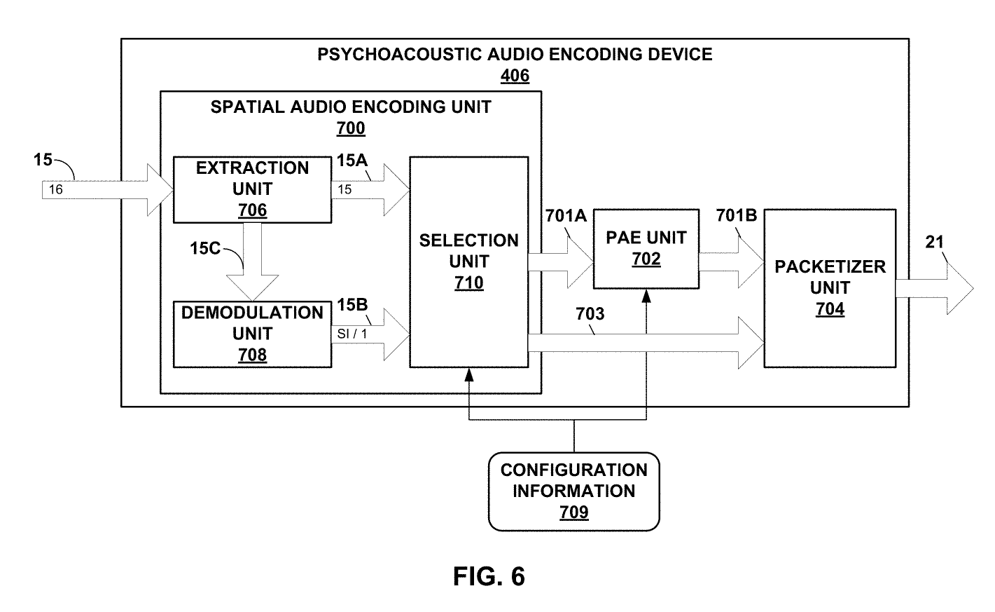

FIG. 6 is a block diagram illustrating an example of the psychoacoustic audio encoding device 406 shown in the examples of FIGS. 2-5B. As shown in the example of FIG. 6, the psychoacoustic audio encoding device 406 may include a spatial audio encoding unit 700, a psychoacoustic audio encoding unit 702, and a packetizer unit 704.

The spatial audio encoding unit 700 may represent a unit configured to perform further spatial audio encoding with respect to the intermediately formatted audio data 15. The spatial audio encoding unit 700 may include an extraction unit 706, a demodulation unit 708 and a selection unit 710.

The extraction unit 706 may represent a unit configured to extract the transport channels 15A and the modulated sideband information 15C from the intermediately formatted bitstream 15. The extraction unit 706 may output the transport channels 15A to the selection unit 710, and the modulated sideband information 15C to the demodulation unit 708.

The demodulation unit 708 may represent a unit configured to demodulate the modulated sideband information 15C to recover the original sideband information 15B. The demodulation unit 708 may operate in a manner reciprocal to the operation of the modulation device 610 described above with respect to system 800B shown in the example of FIG. 5B. When modulation is not performed with respect to the sideband information 15B, the extraction unit 706 may extract the sideband information 15B directly from the intermediately formatted bitstream 15 and output the sideband information 15B directly to the selection unit 710 (or the demodulation unit 708 may pass through the sideband information 15B to the selection unit 710 without performing demodulation).

The selection unit 710 may represent a unit configured to select, based on configuration information 709, subsets of the transport channels 15A and the sideband information 15B. The configuration information 709 may include a target bitrate, and the above described independency flag (which may be denoted by an hoaIndependencyFlag syntax element). The selection unit 710 may, as one example, select four ambient HOA coefficients from none ambient HOA coefficients, four predominant audio signals from six predominant audio signals, and the four spatial components corresponding to the four selected predominant audio signals from the six total spatial components corresponding to the six predominant audio signals.

The selection unit 710 may output the selected ambient HOA coefficients and predominant audio signals to the PAE unit 702 as transport channels 701A. The selection unit 710 may output the selected spatial components to the packetizer unit 704 as spatial components 703. The techniques enable the selection unit 710 to select various combinations of the transport channels 15A and the sideband information 15B suitable to achieve, as one example, the target bitrate and independency set forth by the configuration information 709 by virtue of the spatial audio encoding device 20 providing the transport channels 15A and the sideband information 15B in the layered manner described above.

The PAE unit 702 may represent a unit configured to perform psychoacoustic audio encoding with respect to the transport channels 701A to generate encoded transport channels 701B. The PAE unit 702 may output the encoded transport channels 701B to the packetizer unit 704. The packetizer unit 704 may represent a unit configured to generate, based on the encoded transport channels 701B and the sideband information 703, the bitstream 21 as a series of packets for delivery to the content consumer 14.

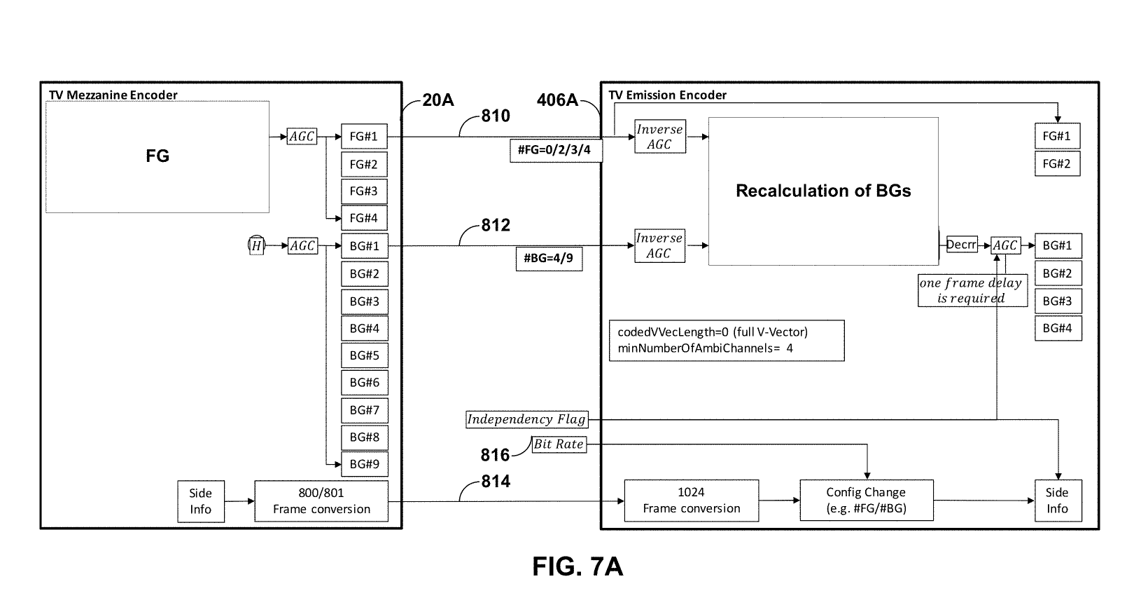

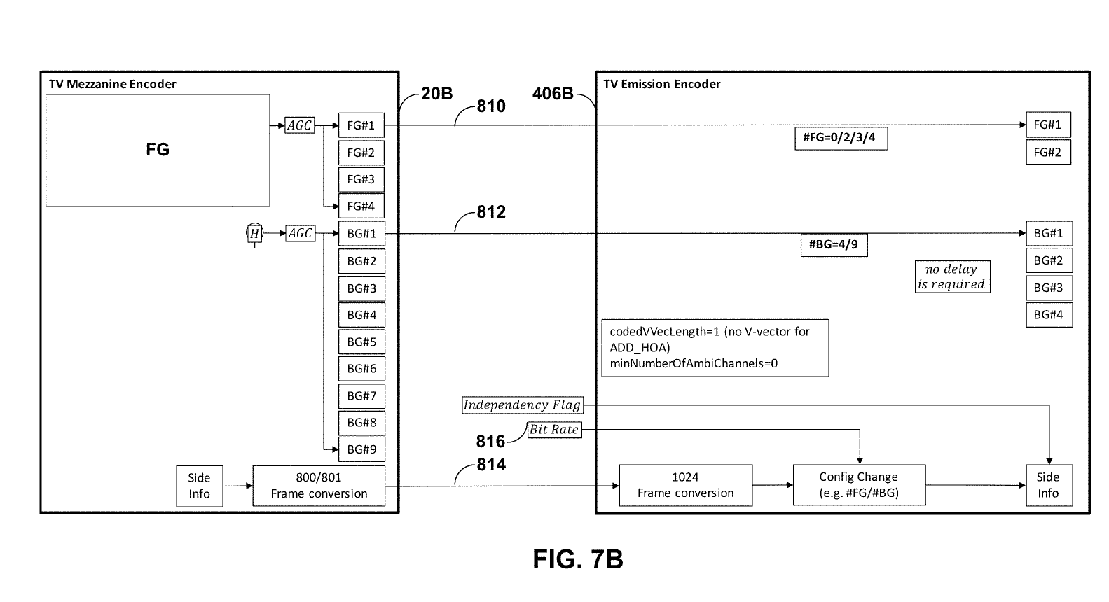

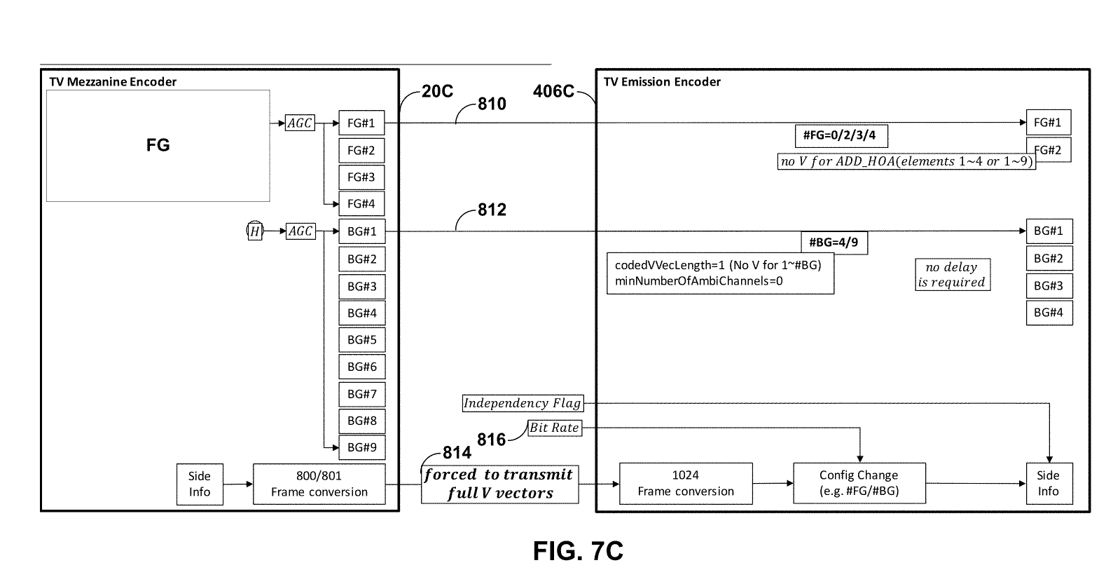

FIGS. 7A-7C are diagrams illustrating example operation for the mezzanine encoder and emission encoders shown in FIG. 2. Referring first to FIG. 7A, the mezzanine encoder 20A (where the mezzanine encoder 20A is one example of the mezzanine encoder 20 shown in FIGS. 2-5B) applies adaptive gain control to FGs and H (shown as “AGC” in FIG. 7A) to generate the four predominant sound components 810 (denoted as FG#1-FG#4 in the example of FIG. 7A) and the nine ambient HOA coefficients 812 (denoted as BG#1-BG#9 in the example of FIG. 7A). In 20A, codedVVecLength=0 and minNumberOfAmbiChannels (or MinNumOfCoeffsForAmbHOA)=0. More information regarding the codedVVecLength and minNumberOfAmbiChannels can be found in the above referenced MPEG-H 3D Audio Coding standard.

However, the mezzanine encoder 20A sends all of the ambient HOA coefficients, including those that provide information redundant to the information provided by the combination of the four predominant sound components and the corresponding spatial components 814 sent via the side information (shown as “side info” in the example of FIG. 7A). As described above, the mezzanine encoder 20A specifies all of the spatial components 814 in a single side information channel, while specifying each of the four predominant sound components 810 in a separate dedicated predominant channel and each of the nine ambient HOA coefficients 812 in a separate dedicated ambient channel.

The emission encoder 406A (where the emission encoder 406A is one example of the emission encoder 406A shown in the example of FIG. 2) may receive the four predominant sound components 810, the nine ambient HOA coefficients 812, and the spatial components 814. In 406A, codedVVecLength=0 and minNumberOfAmbiChannels=4. The emission encoder 406A may apply inverse adaptive gain control to the four predominant sound components 810 and the nine ambient HOA coefficients 812. The emission encoder 406A may then determine parameters to transcode the bitstream 15 comprising the four predominant sound components 810, the nine ambient HOA coefficients 812, and the spatial components 814 based on the target bitrate 816.

When transcoding the bitstream 15, the emission encoder 406A selects only two of the four predominant sound components 810 (i.e., FG#1 and FG#2 in the example of FIG. 7A) and only four of the nine ambient HOA coefficients 812 (i.e., BG#1-BG#4 in the example of FIG. 7A). The emission encoder 406A may therefore vary the number of ambient HOA coefficients 812 included in the bitstream 21, and as such needs access to all of the ambient HOA coefficients 812 (rather than only those not specified by way of the predominant sound components 810).

The emission encoder 406A may perform decorrelation and adaptive gain control with respect to the ambient HOA coefficients 812 remaining after removing the information that is redundant to information specified by the remaining predominant sound components 810 (i.e., FG#1 and FG#2 in the example of FIG. 7A) prior to specifying the remaining ambient HOA coefficients 812 in the bitstream 21. However, this recalculation of BGs may require 1-frame delay. The emission encoder 406A may also specify the remaining predominant sound components 810 and spatial components 814 in the bitstream 21 to form a 3D Audio Coding Standard compliant bitstream.

In the example of FIG. 7B, mezzanine encoder 20B is similar to mezzanine encoder 20A in that the mezzanine encoder 20B operates similar to, if not the same as, the mezzanine encoder 20A. In 20B, codedVVecLength=0 and minNumberOfAmbiChannels=0. However, to reduce latency in transmitting the bitstream 21, the emission encoder 406B of FIG. 7B does not perform the inverse adaptive gain control discussed above with respect to the emission encoder 406A, and thereby avoids the 1-frame delay injected into the processing chain through application of the adaptive gain control. As a result of this change, the emission encoder 406B may not modify the ambient HOA coefficients 812 to remove information redundant to that provided by way of the combination of the remaining predominant sound components 810 and the corresponding spatial components 814. However, the emission encoder 406B may modify the spatial components 814 to remove elements associated with the ambient HOA coefficients 11. The emission encoder 406B is similar to if not the same as the emission encoder 406A in terms of operation in all other ways. In 406B, codedVVecLength=1 and minNumberOfAmbiChannels=0.

In the example of FIG. 7C, mezzanine encoder 20C is similar to mezzanine encoder 20A in that the mezzanine encoder 20C operates similar to, if not the same as, the mezzanine encoder 20A. In 20C, codedVVecLength=1 and minNumberOfAmbiChannels=0. However, the mezzanine encoder 20C transmits all of the elements of the spatial components 814, including every element of V vectors, despite that various elements of the spatial components 814 may provide information redundant to information provided by the ambient HOA coefficients 812. The emission encoder 406C is similar to the emission encoder 406A in that the mission encoder 406C operates similar to, if not the same as, the emission encoder 406A. In 406C, codedVVecLength=1 and minNumberOfAmbiChannels=0. The emission encoder 406C may perform the same transcoding of the bitstream 15 based on the target bitrate 816 as that of the emission encoder 406A, except that in this instance, all of the elements of the spatial components 814 are required to avoid gaps in information should the emission encoder 406C decide to reduce the number of ambient HOA coefficients 11 (i.e., from nine to four as shown in the example of FIG. 7C). Had the mezzanine encoder 20C decided not to send all of elements 1-9 for the spatial components V-vectors (corresponding to BG#1-BG#9), the emission encoder 406C would not have been able to recover elements 5-9 of the spatial components 814. As such, the emission encoder 406C would have been unable to construct the bitstream 21 in a manner that conforms with the 3D Audio Coding Standard.

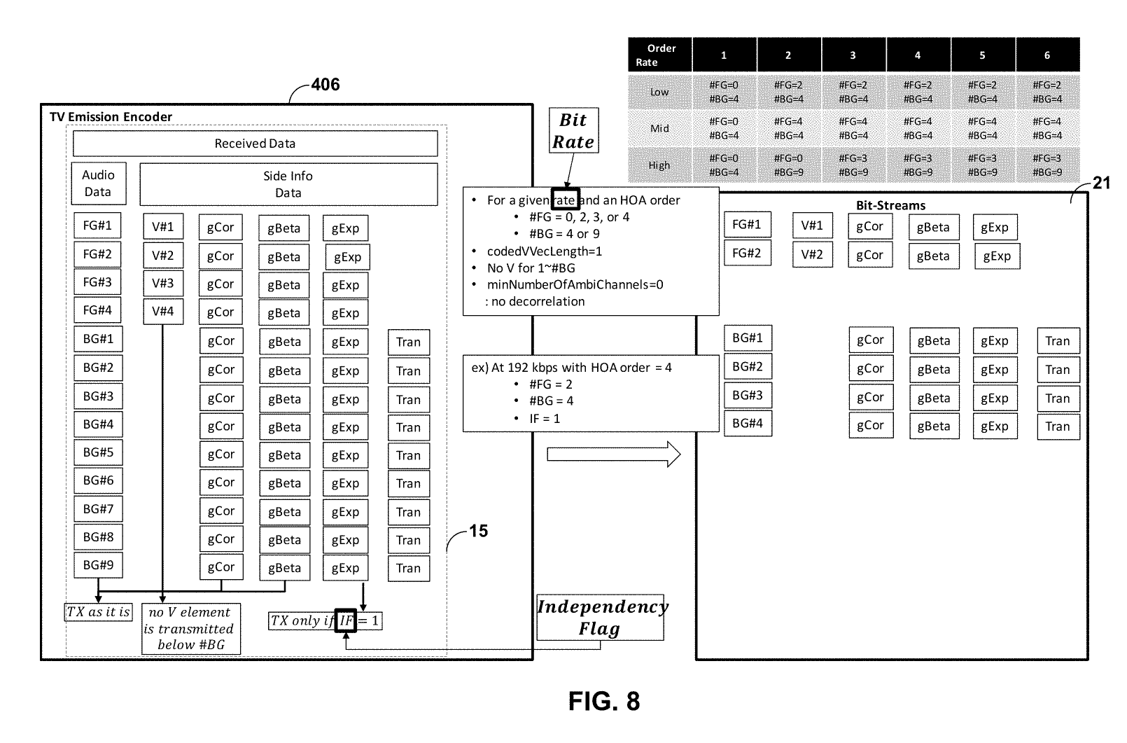

FIG. 8 is a diagram illustrating the emission encoder of FIG. 2 in formulating a bitstream 21 from the bitstream 15 constructed in accordance with various aspects of the techniques described in this disclosure. In the example of FIG. 8, the emission encoder 406 has access to all of the information from the bitstream 15 such that the emission encoder 406 is able to construct the bitstream 21 in a manner that conforms to the 3D Audio Coding Standard.

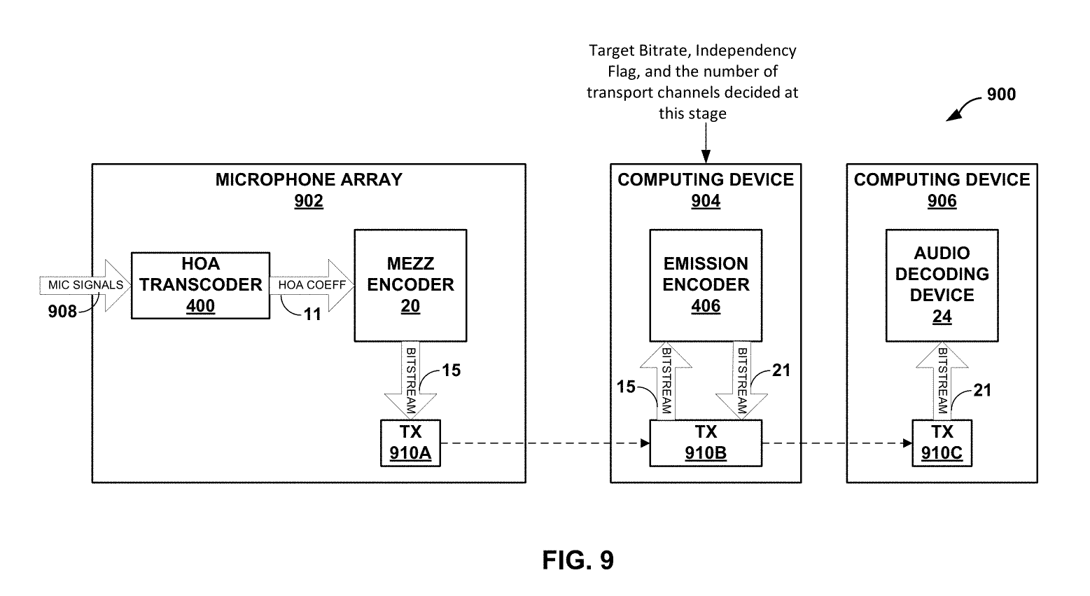

FIG. 9 is a block diagram illustrating a different system configured to perform various aspects of the techniques described in this disclosure. In the example of FIG. 9, a system 900 includes a microphone array 902 and computing device 904 and 906. The microphone array 902 may be similar, if not substantially similar, to the microphone array 5 described above with respect to the example of FIG. 1. The microphone array 902 includes the HOA transcoder 400 and the mezzanine encoder 20 discussed in more detail above.

The computing devices 904 and 906 may each represent one or more of a cellular phone (which may be interchangeably be referred to as a “mobile phone,” or “mobile cellular handset” and where such cellular phone may including so-called “smart phones”), a tablet, a laptop, a personal digital assistant, a wearable computing headset, a watch (including a so-called “smart watch”), a gaming console, a portable gaming console, a desktop computer, a workstation, a server, or any other type of computing device. For purposes of illustration, each of the computing devices 904 and 906 are referred to as mobile phones 904 and 906. In any event, the mobile phone 904 may include the emission encoder 406, while the mobile phone 906 may include the audio decoding device 24.

The microphone array 902 may capture audio data in the form of microphone signals 908. The HOA transcoder 400 of the microphone array 902 may transcode the microphone signals 908 into the HOA coefficients 11, which the mezzanine encoder 20 (shown as “mezz encoder 20”) may encode (or, in other words, compress) to form the bitstream 15 in the manner described above. The microphone array 902 may be coupled (either wirelessly or via a wired connection) to the mobile phone 904 such that the microphone array 902 may communicate the bitstream 15 via a transmitter and/or receiver (which may also be referred to as a transceiver, and abbreviated as “TX”) 910A to the emission encoder 406 of the mobile phone 904. The microphone array 902 may include the transceiver 910A, which may represent hardware or a combination of hardware and software (such as firmware) configured to transmit data to another transceiver.

The emission encoder 406 may operate in the manner described above to generate the bitstream 21 conforming to the 3D Audio Coding Standard from the bitstream 15. The emission encoder 406 may include a transceiver 910B (which is similar to if not substantially similar to transceiver 910A) configured to receive the bitstream 15. The emission encoder 406 may select the target bitrate, hoaIndependencyFlag syntax element, and the number of transport channels when generating the bitstream 21 from the received bitstream 15. The emission encoder 406 may communicate (although not necessarily directly, meaning that such communication may have intervening devices, such as servers, or by way of dedicated non-transitory storage media, etc.) the bitstream 21 via the transceiver 910B to the mobile phone 906.

The mobile phone 906 may include transceiver 910C (which is similar to if not substantially similar to transceivers 910A and 910B) configured to receive the bitstream 21, whereupon the mobile phone 906 may invoke audio decoding device 24 to decode the bitstream 21 so as to recover the HOA coefficients 11′. Although not shown in FIG. 9 for ease of illustration purposes, the mobile phone 906 may render the HOA coefficients 11′ to speaker feeds, and reproduce the soundfield via a speaker (e.g., a loudspeaker integrated into the mobile phone 906, a loudspeaker wirelessly coupled to the mobile phone 906, a loudspeaker coupled by wire to the mobile phone 906, or a headphone speaker coupled either wirelessly or via wired connection to the mobile phone 906) based on the speaker feeds. For reproducing the soundfield by way of headphone speakers, the mobile phone 906 may render binaural audio speaker feeds from either the loudspeaker feeds or directly from the HOA coefficients 11′.

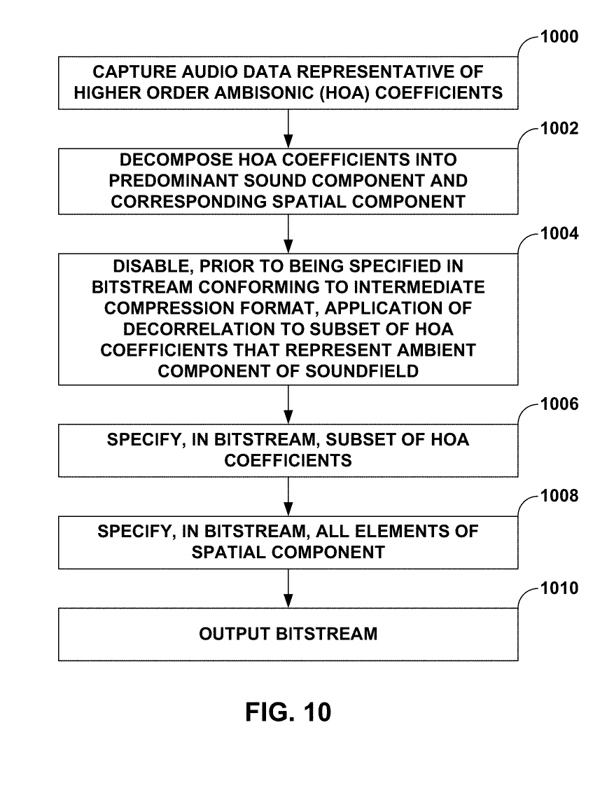

FIG. 10 is a flowchart illustrating example operation of the mezzanine encoder 20 shown in the examples of FIGS. 2-5B. As described in more detail above, the mezzanine encoder 20 may be coupled to the microphones 5, which captures audio data representative of the higher-order ambisonic (HOA) coefficients 11 (1000). The mezzanine encoder 20 decomposes the HOA coefficients 11 into the predominant sound component (which may also be referred to as a “predominant sound signal”) and a corresponding spatial component (1002). The mezzanine encoder 20 disables, prior to being specified in the bitstream 15 conforming to the intermediate compression format, application of decorrelation to the subset of the HOA coefficients 11 that represent the ambient component (1004).

The mezzanine encoder 20 may specify, in a bitstream 15 conforming to an intermediate compression format (which may also be referred to as “scalable mezzanine formatted audio data 15”), a subset of the higher order ambisonic coefficients 11 that represent an ambient component of the soundfield (which also may be referred to as noted above as the “ambient HOA coefficients”) (1006). The mezzanine encoder 20 may also specify, in the bitstream 15, all elements of the spatial component despite that at least one of the elements of the spatial component includes information that is redundant with respect to information provided by the ambient HOA coefficients (1008). The mezzanine encoder 20 may output the bitstream 15 (1010).

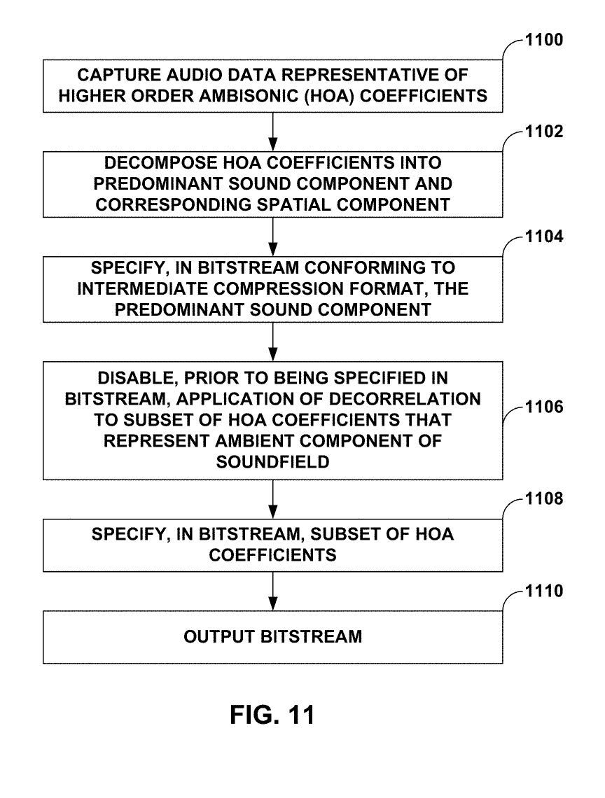

FIG. 11 is a flowchart illustrating different example operation of the mezzanine encoder 20 shown in the examples of FIGS. 2-5B. As described in more detail above, the mezzanine encoder 20 may be coupled to the microphones 5, which captures audio data representative of the higher-order ambisonic (HOA) coefficients 11 (1100). The mezzanine encoder 20 decomposes the HOA coefficients 11 into the predominant sound component (which may also be referred to as a “predominant sound signal”) and a corresponding spatial component (1102). The mezzanine encoder 20 specifies, in the bitstream 15 conforming to the intermediate compression format, the predominant sound component (1104).

The mezzanine encoder 20 disables, prior to being specified in the bitstream 15 conforming to the intermediate compression format, application of decorrelation to the subset of the HOA coefficients 11 that represent the ambient component (1106). The mezzanine encoder 20 may specify, in a bitstream 15 conforming to an intermediate compression format (which may also be referred to as “scalable mezzanine formatted audio data 15”), the subset of the higher order ambisonic coefficients 11 that represent an ambient component of the soundfield (which also may be referred to as noted above as the “ambient HOA coefficients”) (1108). The mezzanine encoder 20 may output the bitstream 15 (1110).

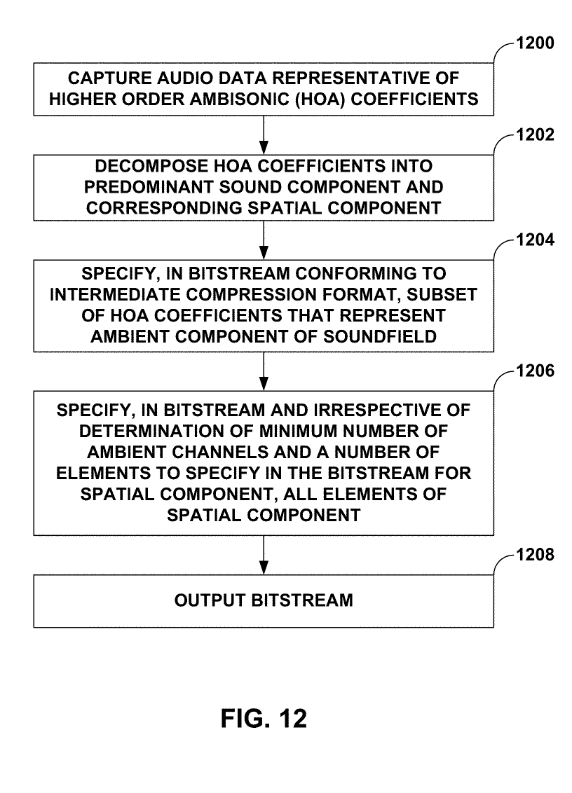

FIG. 12 is a flowchart illustrating example operation of the mezzanine encoder 20 shown in the examples of FIGS. 2-5B. As described in more detail above, the mezzanine encoder 20 may be coupled to the microphones 5, which captures audio data representative of the higher-order ambisonic (HOA) coefficients 11 (1200). The mezzanine encoder 20 decomposes the HOA coefficients 11 into the predominant sound component (which may also be referred to as a “predominant sound signal”) and a corresponding spatial component (1202).

The mezzanine encoder 20 may specify, in a bitstream 15 conforming to an intermediate compression format (which may also be referred to as “scalable mezzanine formatted audio data 15”), the subset of the higher order ambisonic coefficients 11 that represent an ambient component of the soundfield (which also may be referred to as noted above as the “ambient HOA coefficients”) (1204). The mezzanine encoder 20 specifies, in the bitstream 15 and irrespective of a determination of a number of minimum number of ambient channels and a number of elements to specify in the bitstream for the spatial component, all elements of the predominant sound component (1206). The mezzanine encoder 20 may output the bitstream 15 (1208).

In this respect, three dimensional (3D) (or HOA-based) audio may be designed to go beyond 5.1 or even 7.1 channel-based surround sound to provide a more vivid soundscape. In other words, the 3D audio may be designed to envelop the listener so that the listener feels like the source of the sound, whether the musician or the actor for example, is performing live in the same room as the listener. The 3D audio may present new options for content creators looking to craft greater depth and realism into digital soundscapes.

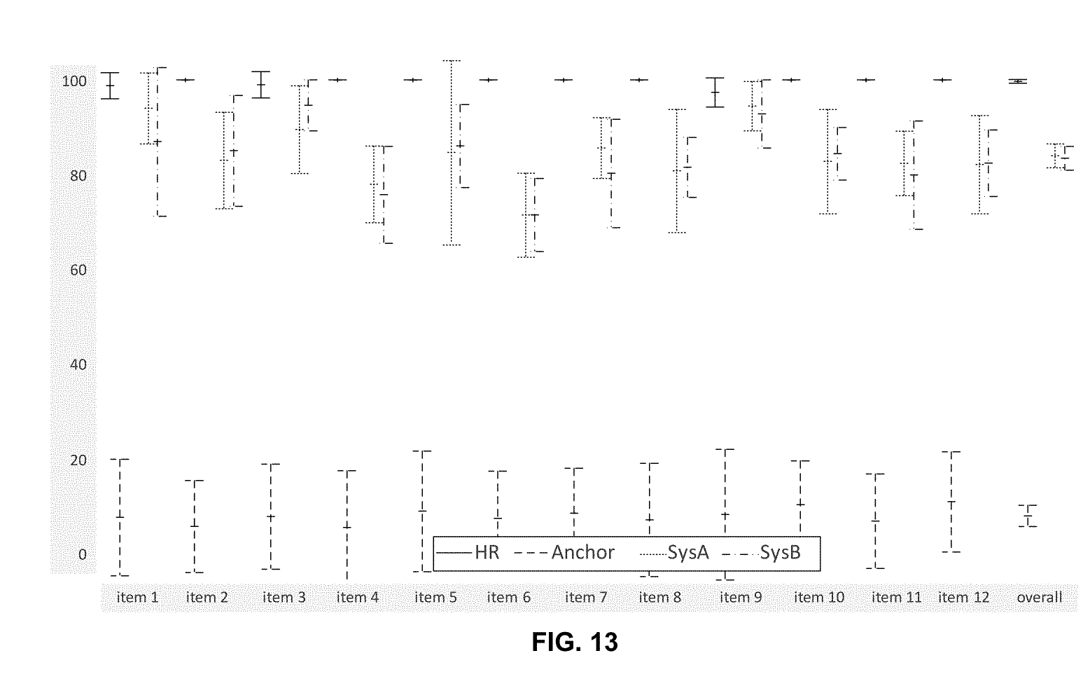

FIG. 13 is a diagram illustrating results from different coding systems, including one performing various aspects of the techniques set forth in this disclosure, relative to one another. On the left of the graph (i.e., the y-axis) is a qualitative score (higher is better) for each of the test listening items (i.e., items 1-12 and an overall item) listed along the bottom of the graph (i.e., the x-axis). Four systems are compared with each of the four systems being denoted “HR” (a hidden reference which represents the uncompressed original signal), “Anchor” (representative of a lowpass filtered—at, as one example, 3.5 kHz—version of HR), “SysA” (which was configured to perform the MPEG-H 3D Audio coding standard) and “SysB” (which was configured to perform various aspects of the techniques described in this disclosure, such as those described above with respect to FIG. 7C). The bitrate configured for each of the above four coding systems was 384 kilobits per second (kbps). As shown in the example of FIG. 13, SysB produced the similar audio quality compared with SysA although SysB has two separate encoders which are mezzanine and emission encoders.

3D audio coding, described in detail above, may include a novel scene-based audio HOA representation format that may be designed to overcome some limitations of traditional audio coding. Scene based audio may represent the three dimensional sound scene (or equivalently the pressure field) using a very efficient and compact set of signals known as higher order ambisonics (HOA) based on spherical harmonic basis functions.

In some instances, content creation may be closely tied to how the content will be played back. The scene based audio format (such as those defined in the above referenced MPEG-H 3D audio standard) may support content creation of one single representation of the sound scene regardless of the system that plays the content. In this way, the single representation may be played back on a 5.1, 7.1, 7.4.1, 11.1, 22.2, etc. playback system. Because the representation of the sound field may not be tied to how the content will be played back (e.g. over stereo or 5.1 or 7.1 systems), the scene-based audio (or, in other words, HOA) representation is designed to be played back across all playback scenarios. The scene-based audio representation may also be amenable for both live capture and for recorded content and may be engineered to fit into existing infrastructure for audio broadcast and streaming as described above.

Although described as a hierarchical representation of a soundfield, the HOA coefficients may also be characterized as a scene-based audio representation. As such, the mezzanine compression or encoding may also be referred to as a scene-based compression or encoding.

The scene based audio representation may offer several value propositions to the broadcast industry, such as the following:
Potentially easy capture of live audio scene: Signals captured from microphone arrays and/or spot microphones may be converted into HOA coefficients in real time.
Potentially flexible rendering: Flexible rendering may allow for the reproduction of the immersive auditory scene regardless of speaker configuration at playback location and on headphones.
Potentially minimal infrastructure upgrade: The existing infrastructure for audio broadcast that is currently employed for transmitting channel based spatial audio (e.g. 5.1 etc.) may be leveraged without making any significant changes to enable transmission of HOA representation of the sound scene.

In addition, the foregoing techniques may be performed with respect to any number of different contexts and audio ecosystems and should not be limited to any of the contexts or audio ecosystems described above. A number of example contexts are described below, although the techniques should be limited to the example contexts. One example audio ecosystem may include audio content, movie studios, music studios, gaming audio studios, channel based audio content, coding engines, game audio stems, game audio coding/rendering engines, and delivery systems.

The movie studios, the music studios, and the gaming audio studios may receive audio content. In some examples, the audio content may represent the output of an acquisition. The movie studios may output channel based audio content (e.g., in 2.0, 5.1, and 7.1) such as by using a digital audio workstation (DAW). The music studios may output channel based audio content (e.g., in 2.0, and 5.1) such as by using a DAW. In either case, the coding engines may receive and encode the channel based audio content based one or more codecs (e.g., AAC, AC3, Dolby True HD, Dolby Digital Plus, and DTS Master Audio) for output by the delivery systems. The gaming audio studios may output one or more game audio stems, such as by using a DAW. The game audio coding/rendering engines may code and or render the audio stems into channel based audio content for output by the delivery systems. Another example context in which the techniques may be performed comprises an audio ecosystem that may include broadcast recording audio objects, professional audio systems, consumer on-device capture, HOA audio format, on-device rendering, consumer audio, TV, and accessories, and car audio systems.

The broadcast recording audio objects, the professional audio systems, and the consumer on-device capture may all code their output using HOA audio format. In this way, the audio content may be coded using the HOA audio format into a single representation that may be played back using the on-device rendering, the consumer audio, TV, and accessories, and the car audio systems. In other words, the single representation of the audio content may be played back at a generic audio playback system (i.e., as opposed to requiring a particular configuration such as 5.1, 7.1, etc.), such as audio playback system 16.

Other examples of context in which the techniques may be performed include an audio ecosystem that may include acquisition elements, and playback elements. The acquisition elements may include wired and/or wireless acquisition devices (e.g., Eigen microphones), on-device surround sound capture, and mobile devices (e.g., smartphones and tablets). In some examples, wired and/or wireless acquisition devices may be coupled to mobile device via wired and/or wireless communication channel(s).

In accordance with one or more techniques of this disclosure, the mobile device (such as a mobile communication handset) may be used to acquire a soundfield. For instance, the mobile device may acquire a soundfield via the wired and/or wireless acquisition devices and/or the on-device surround sound capture (e.g., a plurality of microphones integrated into the mobile device). The mobile device may then code the acquired soundfield into the HOA coefficients for playback by one or more of the playback elements. For instance, a user of the mobile device may record (acquire a soundfield of) a live event (e.g., a meeting, a conference, a play, a concert, etc.), and code the recording into HOA coefficients.

The mobile device may also utilize one or more of the playback elements to playback the HOA coded soundfield. For instance, the mobile device may decode the HOA coded soundfield and output a signal to one or more of the playback elements that causes the one or more of the playback elements to recreate the soundfield. As one example, the mobile device may utilize the wireless and/or wireless communication channels to output the signal to one or more speakers (e.g., speaker arrays, sound bars, etc.). As another example, the mobile device may utilize docking solutions to output the signal to one or more docking stations and/or one or more docked speakers (e.g., sound systems in smart cars and/or homes). As another example, the mobile device may utilize headphone rendering to output the signal to a set of headphones, e.g., to create realistic binaural sound.

In some examples, a particular mobile device may both acquire a 3D soundfield and playback the same 3D soundfield at a later time. In some examples, the mobile device may acquire a 3D soundfield, encode the 3D soundfield into HOA, and transmit the encoded 3D soundfield to one or more other devices (e.g., other mobile devices and/or other non-mobile devices) for playback.

Yet another context in which the techniques may be performed includes an audio ecosystem that may include audio content, game studios, coded audio content, rendering engines, and delivery systems. In some examples, the game studios may include one or more DAWs which may support editing of HOA signals. For instance, the one or more DAWs may include HOA plugins and/or tools which may be configured to operate with (e.g., work with) one or more game audio systems. In some examples, the game studios may output new stem formats that support HOA. In any case, the game studios may output coded audio content to the rendering engines which may render a soundfield for playback by the delivery systems.

The techniques may also be performed with respect to exemplary audio acquisition devices. For example, the techniques may be performed with respect to an Eigen microphone which may include a plurality of microphones that are collectively configured to record a 3D soundfield. In some examples, the plurality of microphones of Eigen microphone may be located on the surface of a substantially spherical ball with a radius of approximately 4 cm. In some examples, the audio encoding device 20 may be integrated into the Eigen microphone so as to output a bitstream 21 directly from the microphone.

Another exemplary audio acquisition context may include a production truck which may be configured to receive a signal from one or more microphones, such as one or more Eigen microphones. The production truck may also include an audio encoder, such as audio encoder 20 of FIG. 5.

The mobile device may also, in some instances, include a plurality of microphones that are collectively configured to record a 3D soundfield. In other words, the plurality of microphone may have X, Y, Z diversity. In some examples, the mobile device may include a microphone which may be rotated to provide X, Y, Z diversity with respect to one or more other microphones of the mobile device. The mobile device may also include an audio encoder, such as audio encoder 20 of FIG. 5.

A ruggedized video capture device may further be configured to record a 3D soundfield. In some examples, the ruggedized video capture device may be attached to a helmet of a user engaged in an activity. For instance, the ruggedized video capture device may be attached to a helmet of a user whitewater rafting. In this way, the ruggedized video capture device may capture a 3D soundfield that represents the action all around the user (e.g., water crashing behind the user, another rafter speaking in front of the user, etc. . . . ).

The techniques may also be performed with respect to an accessory enhanced mobile device, which may be configured to record a 3D soundfield. In some examples, the mobile device may be similar to the mobile devices discussed above, with the addition of one or more accessories. For instance, an Eigen microphone may be attached to the above noted mobile device to form an accessory enhanced mobile device. In this way, the accessory enhanced mobile device may capture a higher quality version of the 3D soundfield than just using sound capture components integral to the accessory enhanced mobile device.

Example audio playback devices that may perform various aspects of the techniques described in this disclosure are further discussed below. In accordance with one or more techniques of this disclosure, speakers and/or sound bars may be arranged in any arbitrary configuration while still playing back a 3D soundfield. Moreover, in some examples, headphone playback devices may be coupled to a decoder 24 via either a wired or a wireless connection. In accordance with one or more techniques of this disclosure, a single generic representation of a soundfield may be utilized to render the soundfield on any combination of the speakers, the sound bars, and the headphone playback devices.

A number of different example audio playback environments may also be suitable for performing various aspects of the techniques described in this disclosure. For instance, a 5.1 speaker playback environment, a 2.0 (e.g., stereo) speaker playback environment, a 9.1 speaker playback environment with full height front loudspeakers, a 22.2 speaker playback environment, a 16.0 speaker playback environment, an automotive speaker playback environment, and a mobile device with ear bud playback environment may be suitable environments for performing various aspects of the techniques described in this disclosure.

In accordance with one or more techniques of this disclosure, a single generic representation of a soundfield may be utilized to render the soundfield on any of the foregoing playback environments. Additionally, the techniques of this disclosure enable a rendered to render a soundfield from a generic representation for playback on the playback environments other than that described above. For instance, if design considerations prohibit proper placement of speakers according to a 7.1 speaker playback environment (e.g., if it is not possible to place a right surround speaker), the techniques of this disclosure enable a render to compensate with the other 6 speakers such that playback may be achieved on a 6.1 speaker playback environment.

Moreover, a user may watch a sports game while wearing headphones. In accordance with one or more techniques of this disclosure, the 3D soundfield of the sports game may be acquired (e.g., one or more Eigen microphones may be placed in and/or around the baseball stadium), HOA coefficients corresponding to the 3D soundfield may be obtained and transmitted to a decoder, the decoder may reconstruct the 3D soundfield based on the HOA coefficients and output the reconstructed 3D soundfield to a renderer, the renderer may obtain an indication as to the type of playback environment (e.g., headphones), and render the reconstructed 3D soundfield into signals that cause the headphones to output a representation of the 3D soundfield of the sports game.

In each of the various instances described above, it should be understood that the audio encoding device 20 may perform a method or otherwise comprise means to perform each step of the method for which the audio encoding device 20 is configured to perform In some instances, the means may comprise one or more processors. In some instances, the one or more processors may represent a special purpose processor configured by way of instructions stored to a non-transitory computer-readable storage medium. In other words, various aspects of the techniques in each of the sets of encoding examples may provide for a non-transitory computer-readable storage medium having stored thereon instructions that, when executed, cause the one or more processors to perform the method for which the audio encoding device 20 has been configured to perform.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media. Data storage media may be any available media that can be accessed by one or more computers or one or more processors to retrieve instructions, code and/or data structures for implementation of the techniques described in this disclosure. A computer program product may include a computer-readable medium.

Likewise, in each of the various instances described above, it should be understood that the audio decoding device 24 may perform a method or otherwise comprise means to perform each step of the method for which the audio decoding device 24 is configured to perform. In some instances, the means may comprise one or more processors. In some instances, the one or more processors may represent a special purpose processor configured by way of instructions stored to a non-transitory computer-readable storage medium. In other words, various aspects of the techniques in each of the sets of encoding examples may provide for a non-transitory computer-readable storage medium having stored thereon instructions that, when executed, cause the one or more processors to perform the method for which the audio decoding device 24 has been configured to perform.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Moreover, as used herein, “A and/or B” means “A or B”, or both “A and B.”

Various aspects of the techniques have been described. These and other aspects of the techniques are within the scope of the following claims.

1. A device configured to compress higher order ambisonic audio data representative of a soundfield, the device comprising:
a memory configured to store higher order ambisonic coefficients of the higher order ambisonic audio data; and
one or more processors configured to:
decompose the higher order ambisonic coefficients into a predominant sound component and a corresponding spatial component, the corresponding spatial component representative of the directions, shape, and width of the predominant sound component, and defined in the spherical harmonic domain;
specify, in a bitstream conforming to an intermediate compression format, a subset of the higher order ambisonic coefficients that represent an ambient component of the soundfield; and
specify, in the bitstream and irrespective of a determination of a minimum number of ambient channels and a number of elements to specify in the bitstream for the spatial component, all elements of the spatial component.

2. The device of claim 1, wherein the one or more processors are configured to specify, in the bitstream, the subset of the higher order ambisonic coefficients associated with spherical basis functions having an order from zero through two.

3. The device of claim 1,
wherein the predominant sound component comprises a first predominant sound component,
wherein the spatial component comprises a first spatial component,
wherein the one or more processors are configured to:
decompose the higher order ambisonic coefficients into a plurality of predominant sound components that include the first predominant sound component and a corresponding plurality of spatial components that include the first spatial component,
specify, in the bitstream, all elements of each of four of the plurality of spatial components, the four of the plurality of spatial components including the first spatial component; and
specify, in the bitstream, four of the plurality of predominant sound components corresponding to the four of the plurality of spatial components.

4. The device of claim 3, wherein the one or more processors are configured to:
specify all elements of each of the four of the plurality of spatial components in a single side information channel of the bitstream;
specify each of the four of the plurality of predominant sound components in a separate foreground channel of the bitstream; and
specify each of the subset of the higher order ambisonic coefficients in a separate ambient channel of the bitstream.

5. The device of claim 1, wherein the one or more processors are further configured to specify, in the bitstream and without applying decorrelation to the subset of the higher order ambisonic coefficients, the subset of the higher order ambisonic coefficients.

6. The device of claim 1, wherein the intermediate compression format comprises a mezzanine compression format.

7. The device of claim 1, wherein the intermediate compression format comprises a mezzanine compression format used for communication of audio data for broadcast networks.

8. The device of claim 1,
wherein the device comprises a microphone array configured to capture spatial audio data, and
wherein the one or more processors are further configured to convert the spatial audio data into the higher order ambisonic audio data.

9. The device of claim 1, wherein the one or more processors are configured to:
receive the higher order ambisonic audio data; and
output the bitstream to an emission encoder, the emission encoder configured to transcode the bitstream based on a target bitrate.

10. The device of claim 1, further comprising a microphone configured to capture spatial audio data representative of the higher order ambisonic audio data, and convert the spatial audio data to the higher order ambisonic audio data.

11. The device of claim 1, wherein the device comprises a robotic device.

12. The device of claim 1, wherein the device comprises a flying device.

13. A method to compress higher order ambisonic audio data representative of a soundfield, the method comprising:
decomposing higher order ambisonic coefficients representative of a soundfield into a predominant sound component and a corresponding spatial component, the corresponding spatial component representative of the directions, shape, and width of the predominant sound component, and defined in the spherical harmonic domain;
specifying, in a bitstream conforming to an intermediate compression format, a subset of the higher order ambisonic coefficients that represent an ambient component of the soundfield; and
specifying, in the bitstream and irrespective of a determination of a minimum number of ambient channels and a number of elements to specify in the bitstream for the spatial component, all elements of the spatial component.

14. The method of claim 13, wherein specifying the subset of the higher order ambisonic coefficients comprises specifying, in the bitstream, the subset of the higher order ambisonic coefficients associated with spherical basis functions having an order from zero through two.

15. The method of claim 13,
wherein the predominant sound component comprises a first predominant sound component,
wherein the spatial component comprises a first spatial component,
wherein decomposing the higher order ambisonic coefficients comprises decomposing the higher order ambisonic coefficients into a plurality of predominant sound components that include the first predominant sound component and a corresponding plurality of spatial components that include the first spatial component,
wherein specifying all of the elements of the spatial component comprises specifying, in the bitstream, all elements of each of four of the plurality of spatial components, the four of the plurality of spatial components including the first spatial component, and
wherein the method further comprises specifying, in the bitstream, four of the plurality of predominant sound components corresponding to the four of the plurality of spatial components.

16. The method of claim 15,
wherein specifying all of the elements of each of the four of the plurality of spatial components comprises specifying all of the elements of each of the four of the plurality of spatial components in a single side information channel of the bitstream,
wherein specifying the four of the plurality of predominant sound components comprises specifying each of the four of the plurality of predominant sound components in a separate foreground channel of the bitstream, and
wherein specifying the subset of the higher order ambisonic coefficients comprises specifying each of the subset of the higher order ambisonic coefficients in a separate ambient channel of the bitstream.

17. The method of claim 13, further comprising specifying, in the bitstream and without applying decorrelation to the subset of the higher order ambisonic coefficients, the subset of the higher order ambisonic coefficients.

18. The method of claim 13, wherein the intermediate compression format comprises a mezzanine compression format.

19. The method of claim 13, wherein the intermediate compression format comprises a mezzanine compression format used for communication of audio data for broadcast network.

20. The method of claim 13, further comprising:
capturing, by a microphone array, spatial audio data, and
converting the spatial audio data into the higher order ambisonic audio data.

21. The method of claim 13, further comprising:
receiving the higher order ambisonic audio data; and
outputting the bitstream to an emission encoder, the emission encoder configured to transcode the bitstream based on a target bitrate,
wherein the device comprises a mobile communication handset.

22. The method of claim 13, further comprising:
capturing spatial audio data representative of the higher order ambisonic audio data; and
converting the spatial audio data to the higher order ambisonic audio data,
wherein the device comprises a flying device.

23. A non-transitory computer-readable storage medium having stored thereon instructions that, when executed, cause one or more processors to:
decompose higher order ambisonic coefficients representative of a soundfield into a predominant sound component and a corresponding spatial component, the corresponding spatial component representative of the directions, shape, and width of the predominant sound component, and defined in the spherical harmonic domain;
specify, in a bitstream conforming to an intermediate compression format, a subset of the higher order ambisonic coefficients that represent an ambient component of the soundfield; and
specify, in the bitstream and irrespective of a determination of a minimum number of ambient channels and a number of elements to specify in the bitstream for the spatial component, all elements of the spatial component.

24. The non-transitory computer-readable storage medium of claim 23, further storing instructions that, when executed, cause the one or more processors to specify, in the bitstream, the subset of the higher order ambisonic coefficients associated with spherical basis functions having an order from zero through two.

25. The non-transitory computer-readable storage medium of claim 23, further storing instructions that, when executed, cause the one or more processors to specify, in the bitstream and without applying decorrelation to the subset of the higher order ambisonic coefficients, the subset of the higher order ambisonic coefficients.

26. A device configured to compress higher order ambisonic audio data representative of a soundfield, the device comprising:
means for decomposing higher order ambisonic coefficients representative of a soundfield into a predominant sound component and a corresponding spatial component, the corresponding spatial component representative of the directions, shape, and width of the predominant sound component, and defined in the spherical harmonic domain;
means for specifying, in a bitstream conforming to an intermediate compression format, a subset of the higher order ambisonic coefficients that represent an ambient component of the soundfield; and
means for specifying, in the bitstream and irrespective of a determination of a minimum number of ambient channels and a number of elements to specify in the bitstream for the spatial component, all elements of the spatial component.
